(19) United States
(12) Patent Application Publication
(10) Pub. No.: US 2025/0088083 A1
(43) Pub. Date: Mar. 13, 2025

(54) Apparatus for Supporting a Rotor During a Balancing Process

(71) Applicant: Universal Balancing Limited, Warmley Bristol (GB)

(72) Inventors: Steve Fowler, Warmley Bristol (GB); Eric Ainslie, Warmley Bristol (GB); Benjiamin Payne, Warmley Bristol (GB)

(21) Appl. No.: 18/294,363

(22) PCT Filed: Aug. 2, 2021
(86) PCT No.: PCT/GB2021/051997

§ 371 Date: Feb. 1, 2024

(51) Int. Cl. H02K 15/16

(52) U.S. Cl. CPC H02K 15/165; H02K 2215/00

(57) ABSTRACT

An apparatus for supporting a rotor during a balancing process, said rotor including a rotor body and first and second rotor shaft members positioned at either side of the rotor body, the apparatus including: one or more support devices for supporting the rotor and/or one or both shaft members thereof; a first holding device including a first abutment member for engaging, in use, with a first axial end face of the rotor body, a second holding device including a second abutment member for engaging, in use, with a second axial end face of the rotor body, wherein the first and second abutment members each include an abutment surface which in use engages the respective axial end face of the rotor body, and wherein an angle of the abutment surface relative to the rotor axis is moveable.

### FIELD

This invention relates to an apparatus for supporting a rotor during a balancing process. In particular, but not exclusively, this invention relates to an apparatus for supporting a rotor of the kind typically used in an electric motor. It should be appreciated, however, that the invention may be used for supporting many different types of rotors, whether they are intended for an electric motor or other applications.

### BACKGROUND

As with many high speed rotors, the rotor of an electric motor must be balanced to within acceptable tolerances in order to avoid vibration issues during use. Typically, for example in the field of rotors for electric motors, the rotor includes a shaft which rotates about a motor axis and which includes bearing support shaft parts at or near each end, which are supported in the motor housing by suitable bearings. In between the bearing support parts is a rotor body portion which typically supports a plurality of radially spaced magnetic or magnetisable parts. It is these radially spaced magnetic or magnetisable parts which interact with the stator to effect rotation of the rotor during use.

Balancing of such rotors is typically carried out to overcome or lessen the problem of ‘unbalance’—the uneven distribution of mass around the axis of rotation of the rotor. Unbalance is when the inertia axis of the rotor is offset from its central axis of rotation, which results from the mass of the rotor not being distributed uniformly about its central axis. Rotors suffering unbalance may generate a moment when rotating which leads to vibration.

It is known to balance a single piece rotor, e.g. an electric motor rotor, using two balance planes. Each balance plane is a plane disposed substantially perpendicular to the axis of the rotor. Correction for unbalance is typically carried out by either attaching balance weights to the rotor or by removing material from the rotor. Rotors are designed with zones where balance weights can be added or material removed corresponding to the number of balancing planes. In rotors for electric motors, the rotor is typically provided with rotor body portions which are provided solely so that material may be removed therefrom as part of the balancing process. The body portions are provided at respective axial end faces of the rotor body and in examples (but not always) are disc-shaped or annular with a central aperture which is fitted over each bearing support shaft part typically but not always by way of an interference fit. Whilst it is desirable for the axial end faces of these rotor body portions to be parallel with each other once installed, it is more often the case that they are not sufficiently parallel, which can lead to problems during the balancing process.

For such rotors where material is removed from the body portions as part of the balancing process, the removal is achieved by precise drilling of the body portion at the desired angular position (determined by the unbalance measurement). In prior art apparatus, then rotor is held in position and the drill advanced axially towards the body portion, with the drill depth being accurately measured to ensure the required material is precisely removed. In some prior art devices movement or vibration of the rotor during this drilling stage can occur which can result in inaccurate drilling. In particular, it may result in the drilled bore being rough along its length and/or at its entrance (burrs of material may remain connected to the body portion), which can lead to material remaining connected which will detrimentally affect the balance of the rotor. The burrs may of be removed after drilling, but this results in an additional process step adding time and cost of the balancing process.

According to a first aspect of the invention, we provide an apparatus for supporting a rotor during a balancing process, said rotor including a rotor body and first and second rotor shaft members positioned at either side of the rotor body, the apparatus including:
one or more support devices for supporting the rotor and/or one or both shaft members thereof;
a first holding device including a first abutment member for engaging, in use, with a first axial end face of the rotor body,
a second holding device including a second abutment member for engaging, in use, with a second axial end face of the rotor body,
wherein the first and second abutment members each include an abutment surface which in use engages the respective axial end face of the rotor body, and wherein an angle of the abutment surface relative to the rotor axis is moveable.

Further features of the various aspects of the invention are set out in the claims appended hereto.

In order that the present disclosure may be more readily understood, embodiments thereof will now be described, by way of example only, with reference to the accompanying drawings, in which:

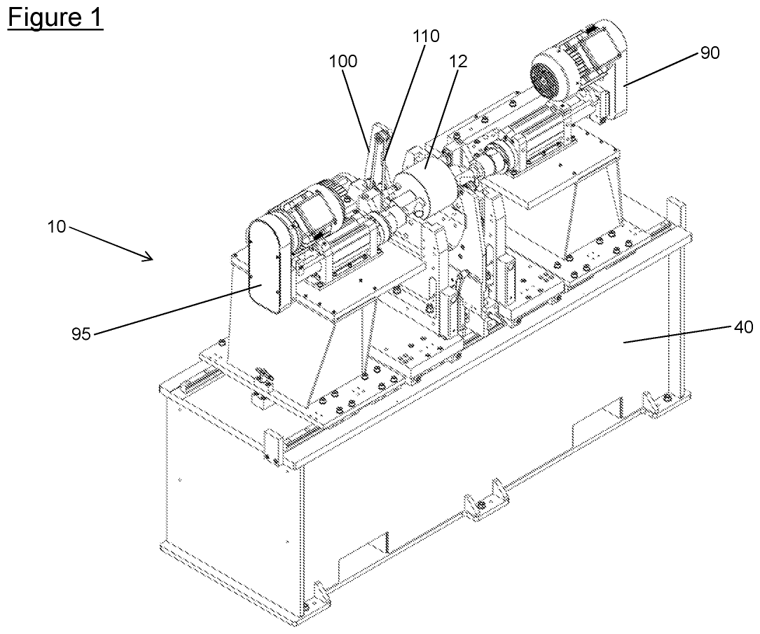

FIG. 1 is a perspective view of a first embodiment of the present disclosure with a rotor in position;

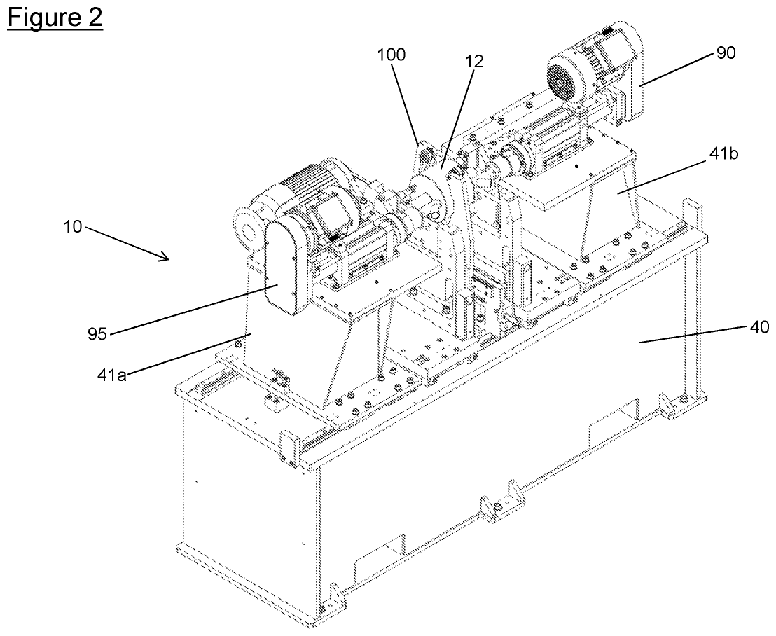

FIG. 2 is a further perspective view of the first embodiment of the present disclosure with a rotor in position;

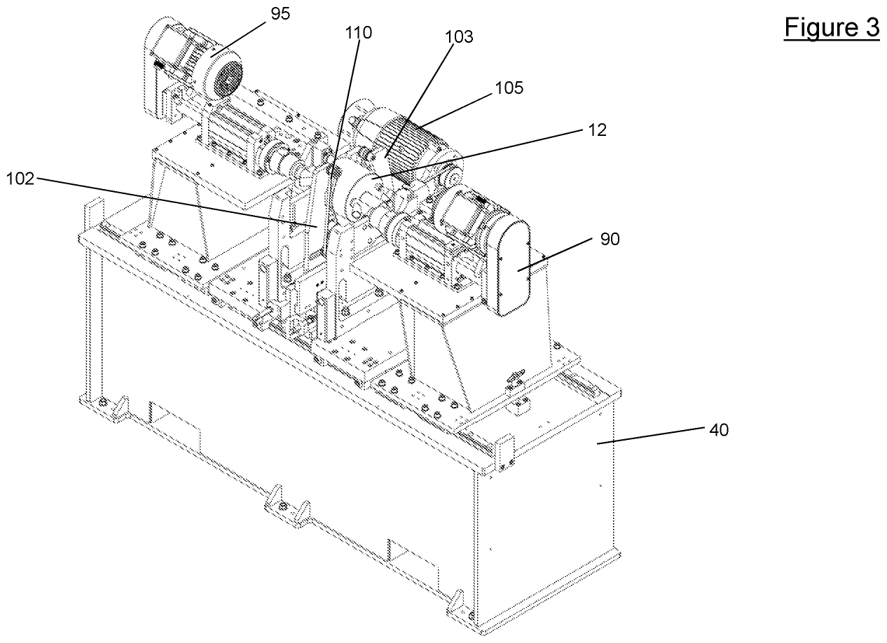

FIG. 3 is a yet further perspective view of the first embodiment of the present disclosure with a rotor in position;

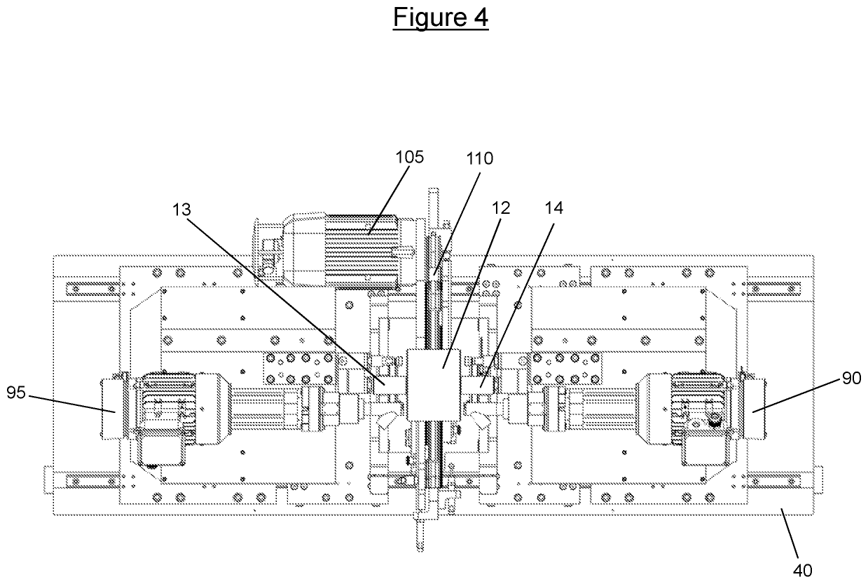

FIG. 4 is a plan view of the first embodiment of the present disclosure with a rotor in position;

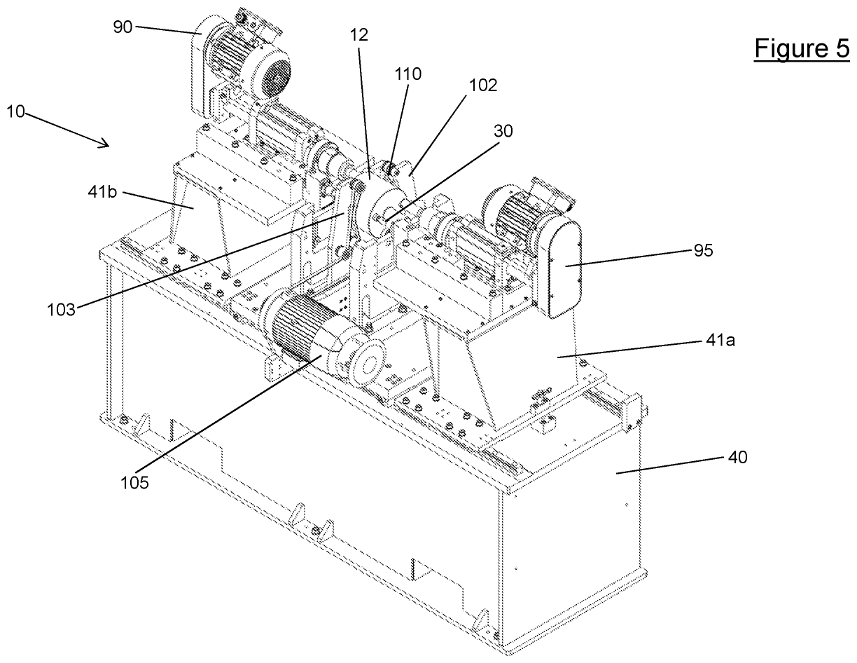

FIG. 5 is a yet further perspective view of the first embodiment of the present disclosure with a rotor in position;

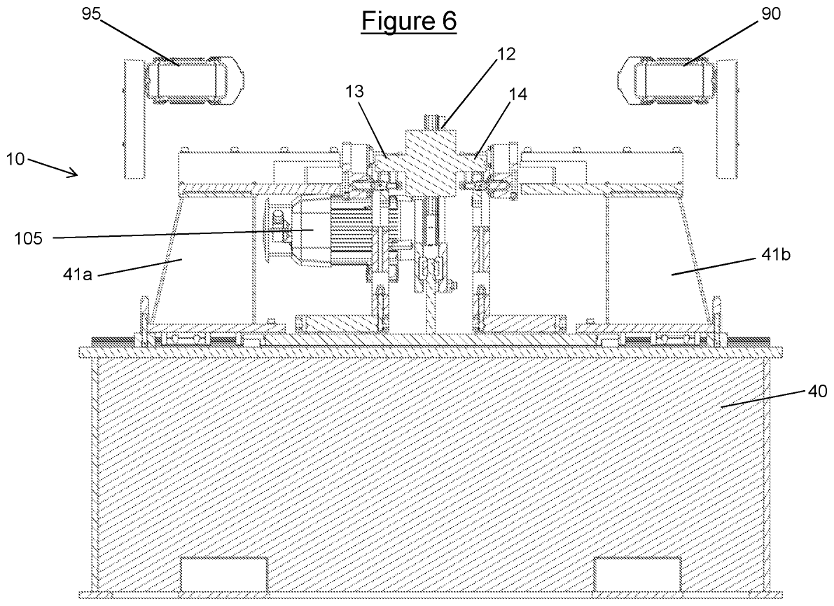

FIG. 6 is a side partially cut-through view of the first embodiment of the present disclosure with a rotor in position;

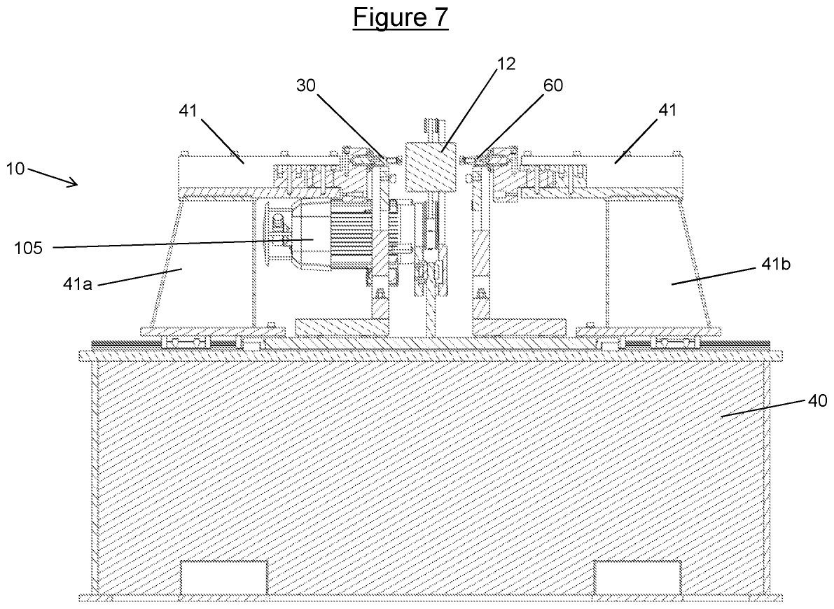

FIG. 7 is a further side partially cut-through view of the first embodiment of the present disclosure with a rotor in position;

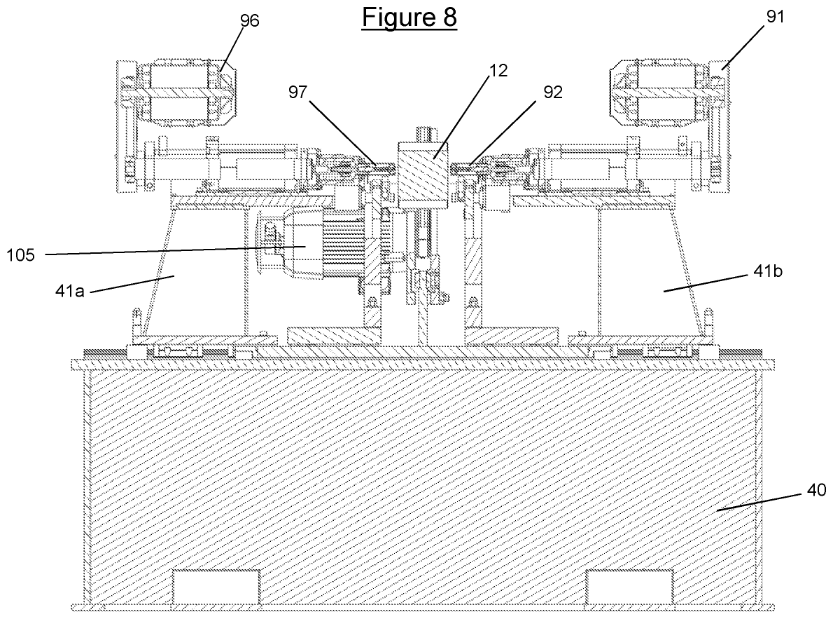

FIG. 8 is a further side partially cut-through view of the first embodiment of the present disclosure with a rotor in position;

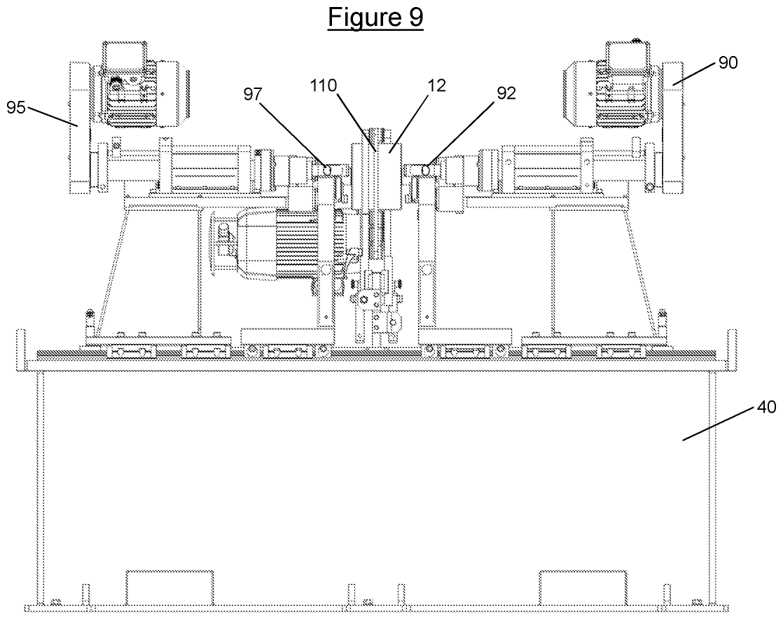

FIG. 9 is a side view of the first embodiment of the present disclosure with a rotor in position;

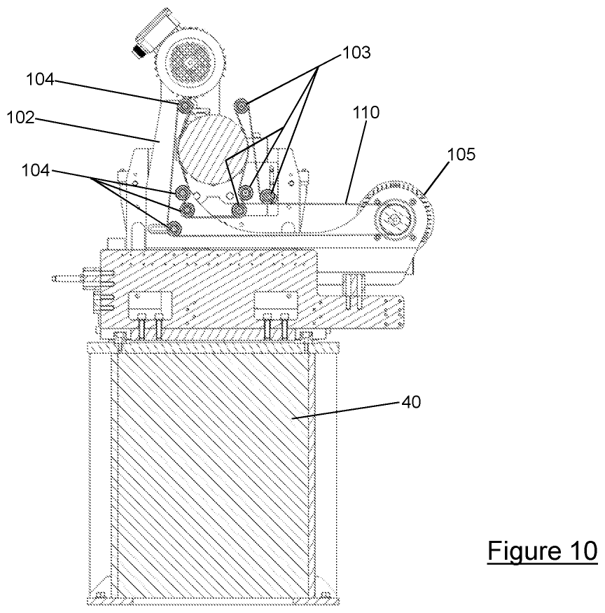

FIG. 10 is an end partially cut-through view of the first embodiment of the present disclosure with a rotor in position;

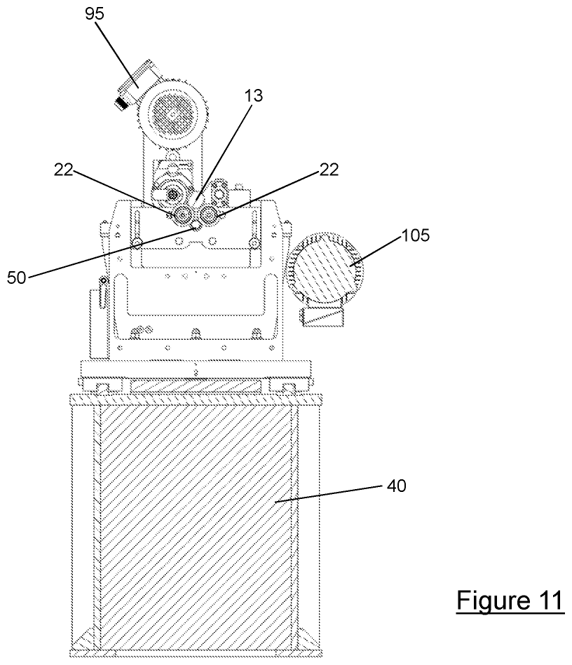

FIG. 11 is an end partially cut-through view of the first embodiment of the present disclosure with a rotor in position;

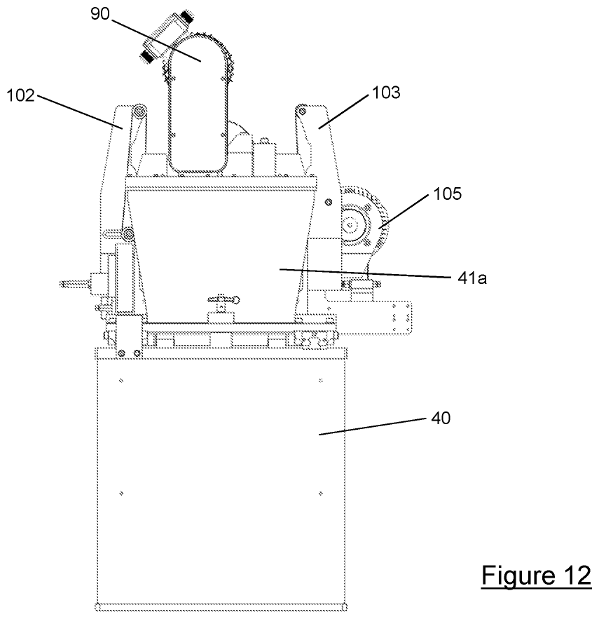

FIG. 12 is an end view of the first embodiment of the present disclosure with a rotor in position;

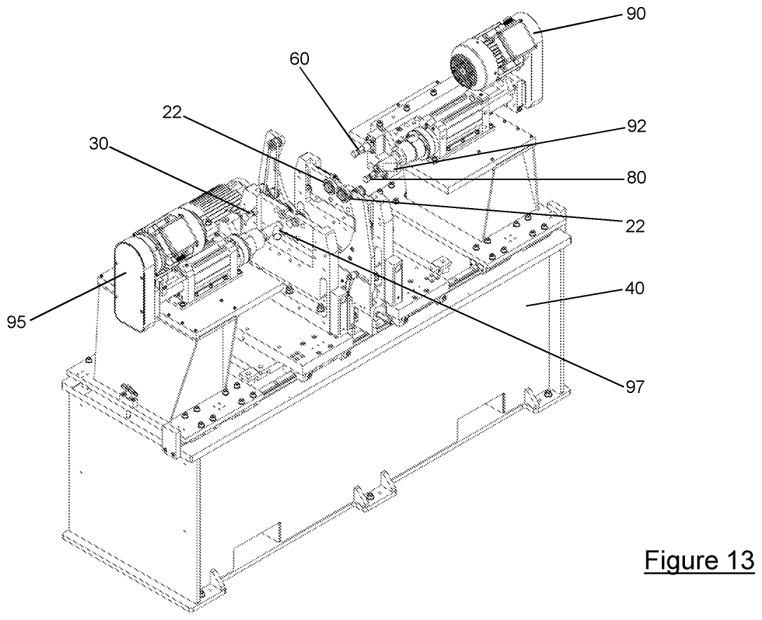

FIG. 13 is a perspective view of the first embodiment of the present disclosure corresponding to FIG. 1, but with the rotor removed;

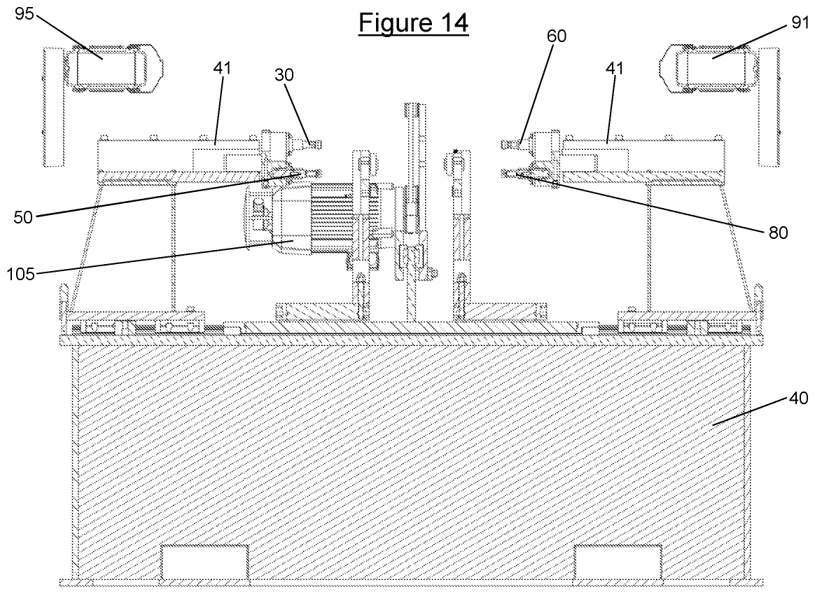

FIG. 14 is a side partially cut-through view of the first embodiment of the present disclosure, but with the rotor removed;

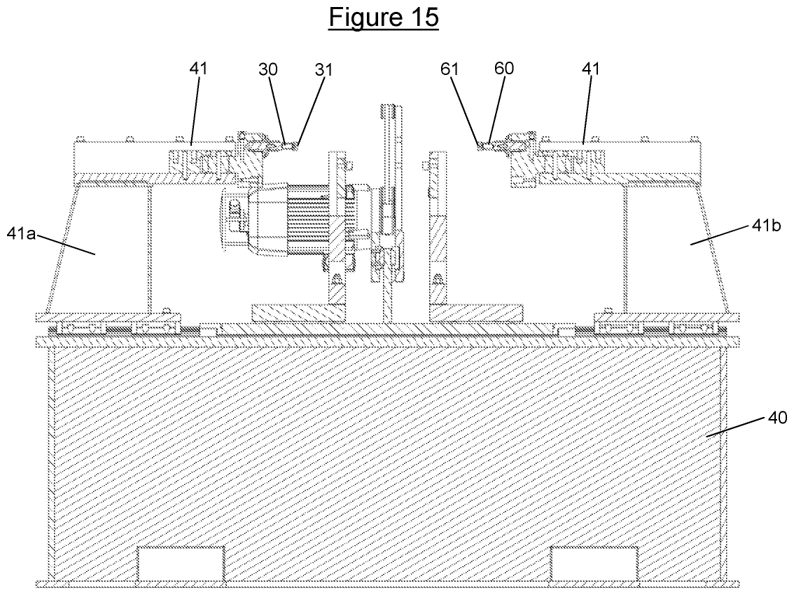

FIG. 15 is a further side partially cut-through view of the first embodiment of the present, but with the rotor removed;

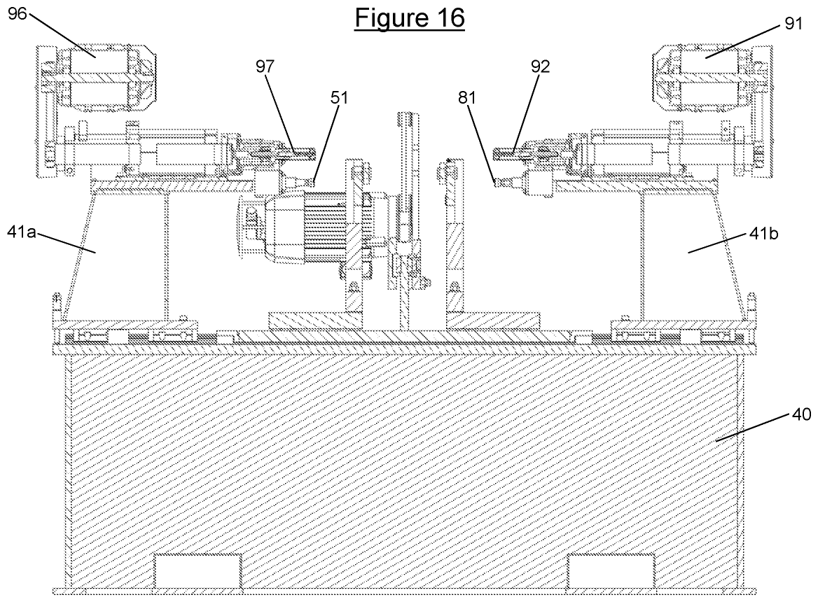

FIG. 16 is a further side partially cut-through view of the first embodiment of the present, but with the rotor removed;

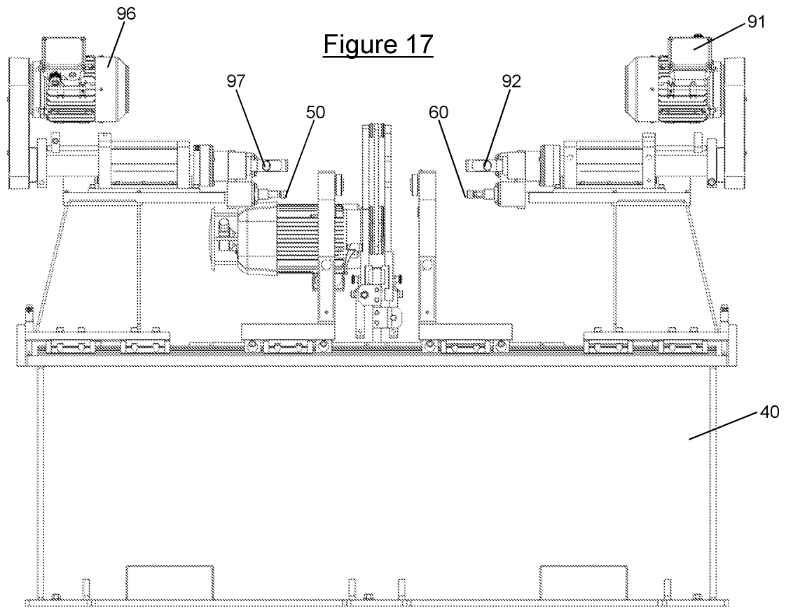

FIG. 17 is a side view of the first embodiment of the present disclosure, but with the rotor removed;

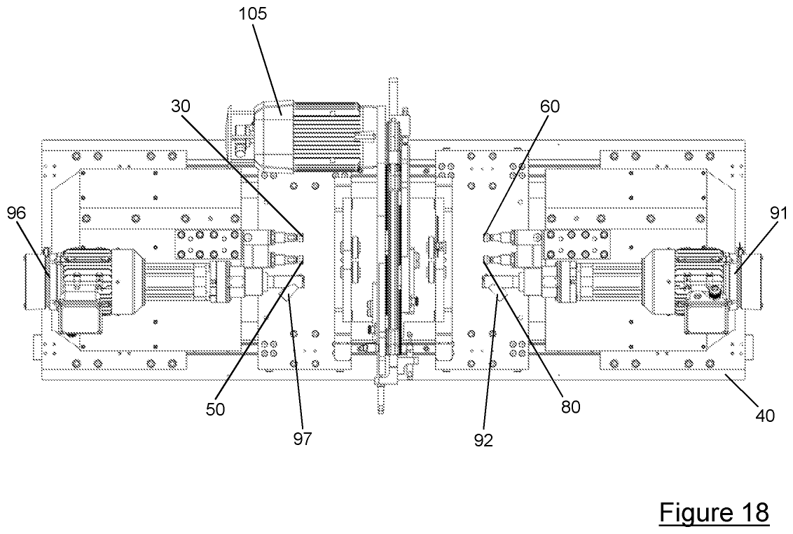

FIG. 18 is a plan view of the first embodiment of the present disclosure, but with the rotor removed;

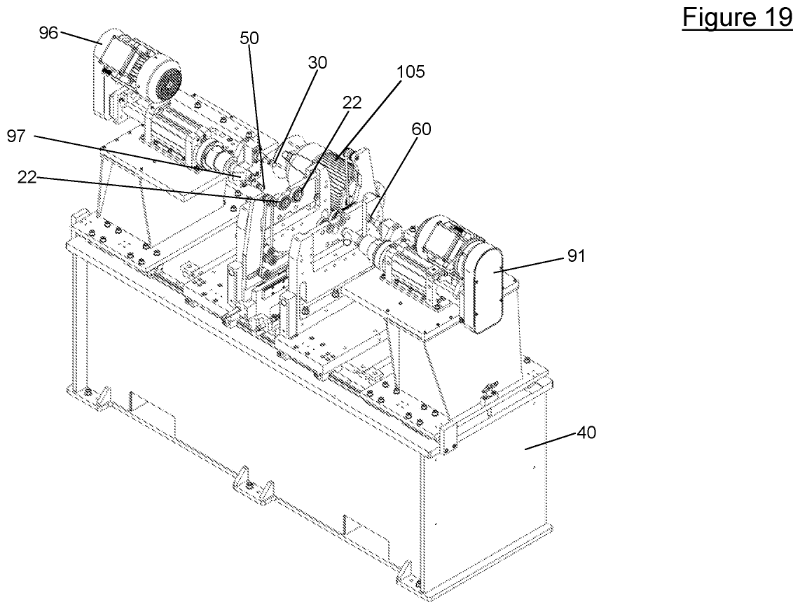

FIG. 19 is a perspective view of the first embodiment of the present disclosure corresponding to FIG. 2, but with the rotor removed;

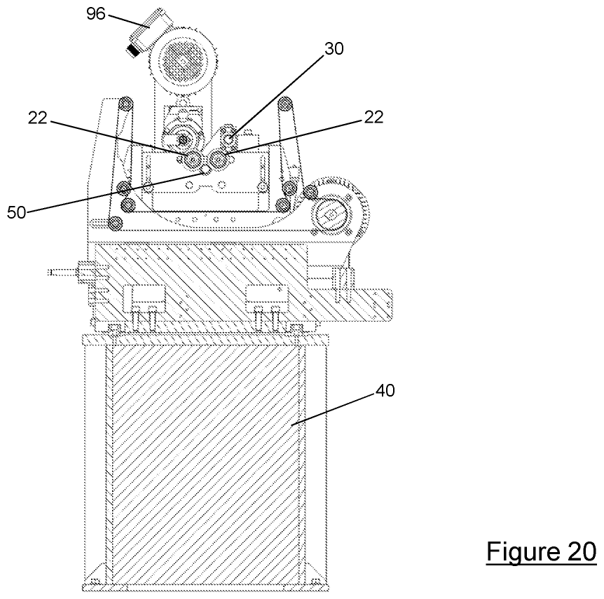

FIG. 20 is a side partially cut-through view of the first embodiment of the present disclosure, but with the rotor removed;

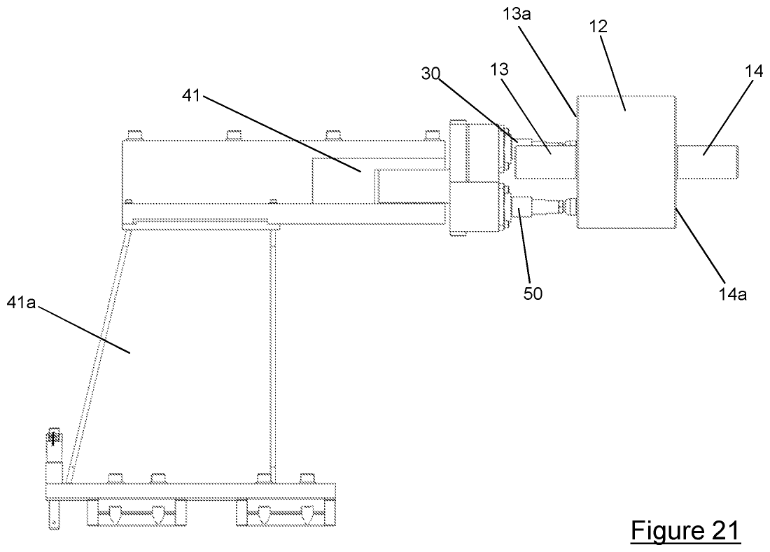

FIG. 21 is a side view of component parts of the first embodiment of the present disclosure with the rotor in position;

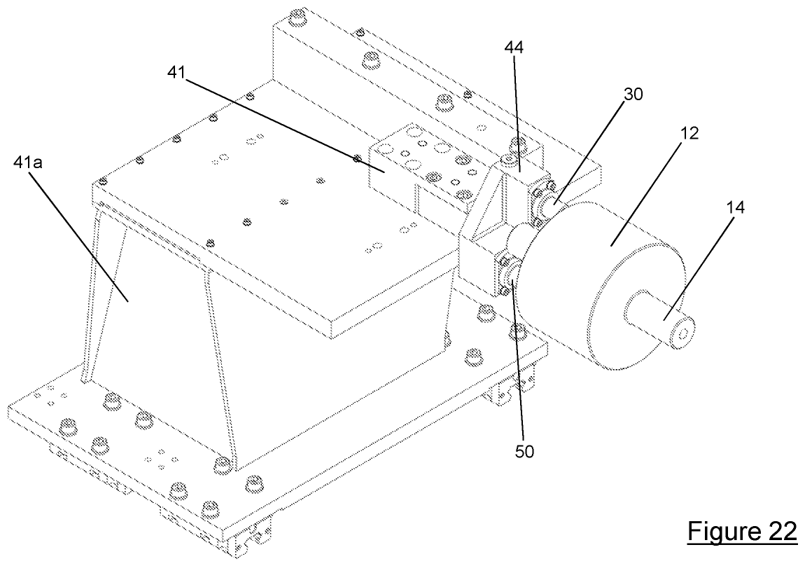

FIG. 22 is a perspective view of component parts of the first embodiment of the present disclosure with the rotor in position;

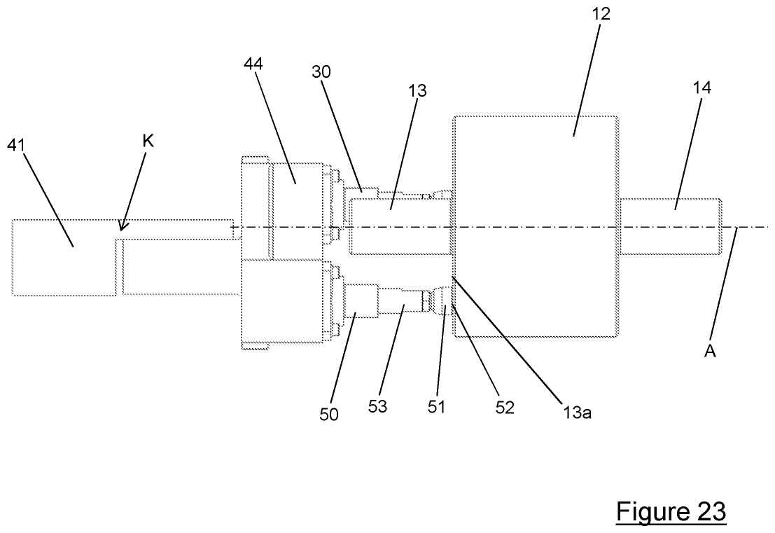

FIG. 23 is a side view of component parts of the first embodiment of the present disclosure with the rotor in position;

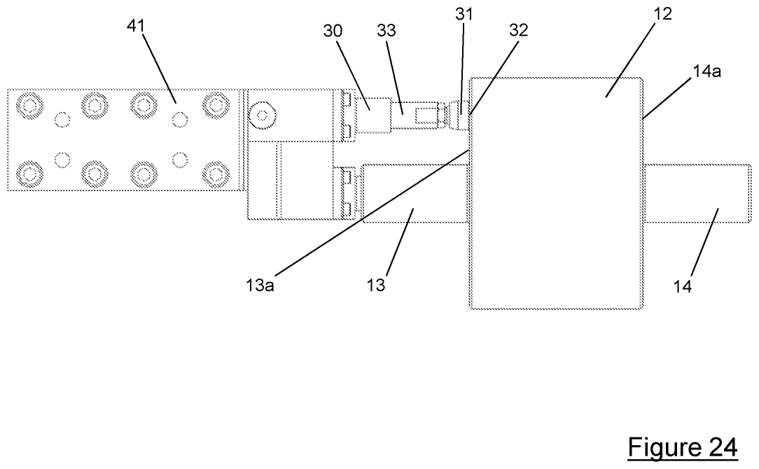

FIG. 24 is a plan view of component parts of the first embodiment of the present disclosure with the rotor in position;

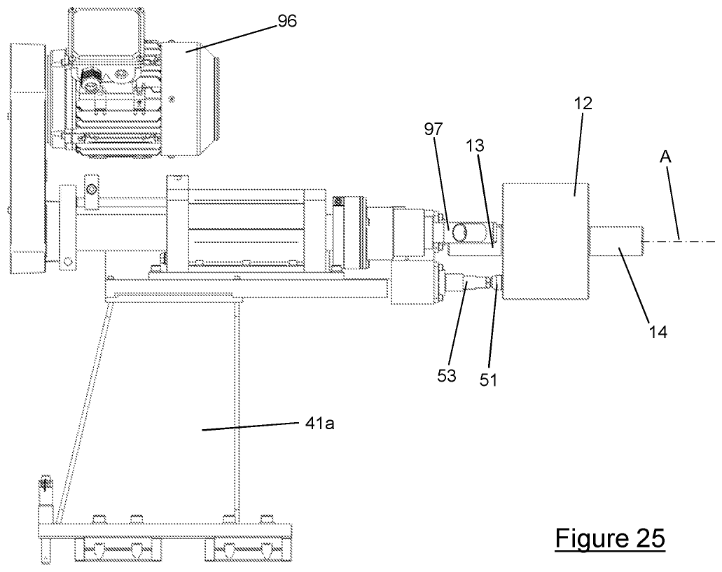

FIG. 25 is a side view of component parts of the first embodiment of the present disclosure with the rotor in position;

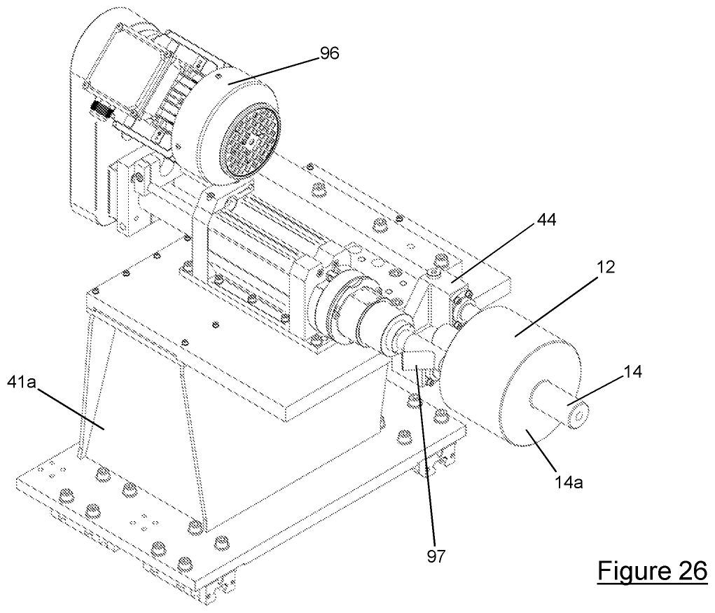

FIG. 26 is a perspective view of component parts of the first embodiment of the present disclosure with the rotor in position;

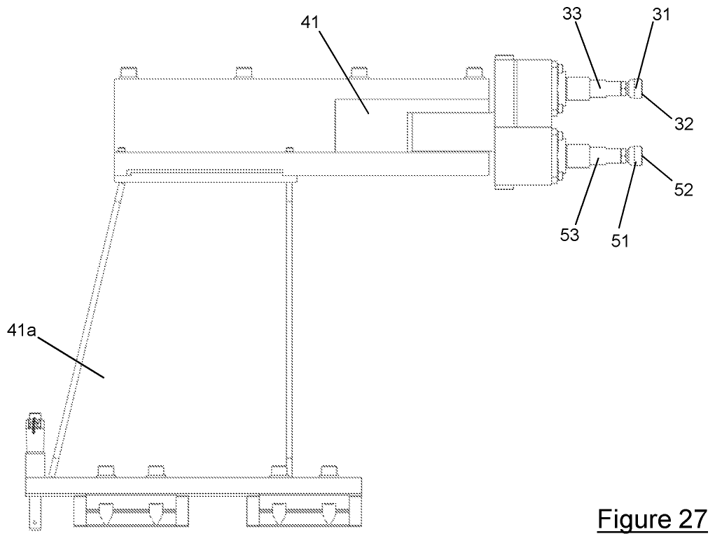

FIG. 27 is a side view of component parts of the first embodiment of the present disclosure, but with the rotor removed;

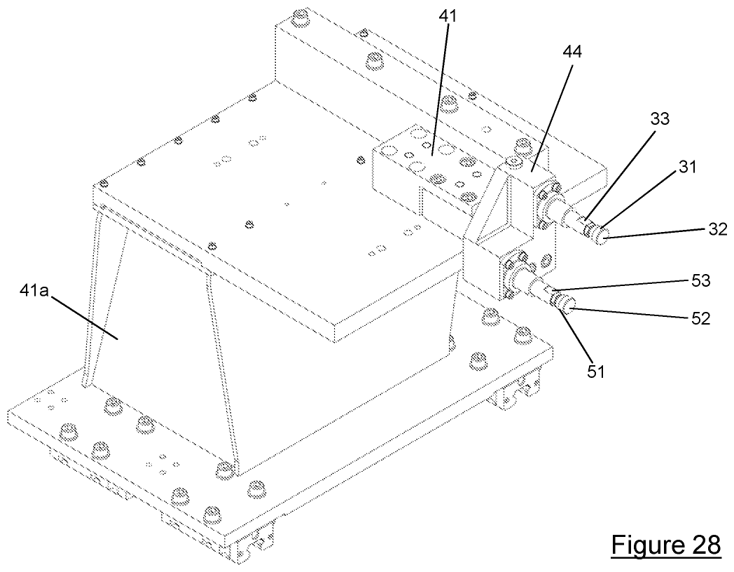

FIG. 28 is a perspective view of component parts of the first embodiment of the present disclosure, but with the rotor removed;

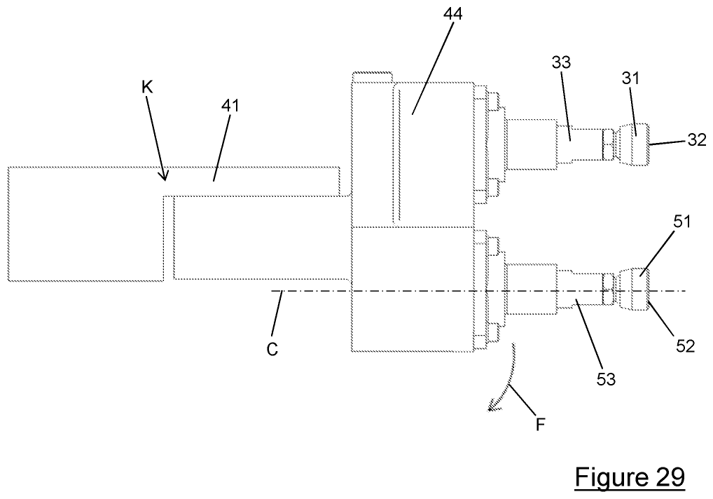

FIG. 29 is a side view of component parts of the first embodiment of the present disclosure, but with the rotor removed;

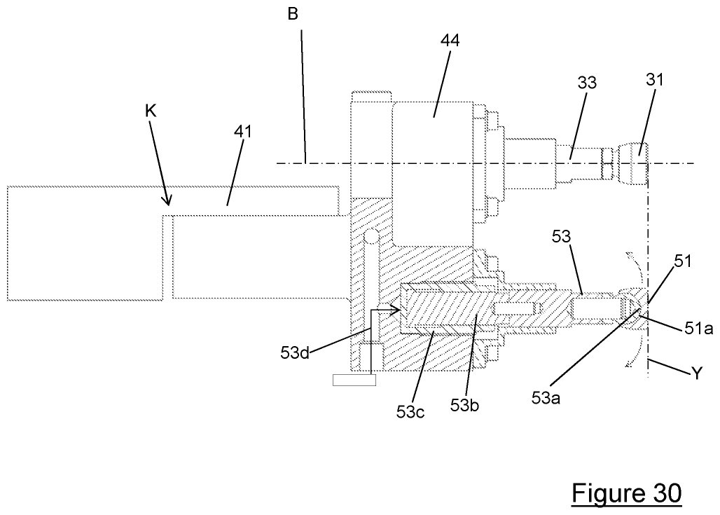

FIG. 30 is a side partially cut-through view of component parts of the first embodiment of the present disclosure, but with the rotor removed;

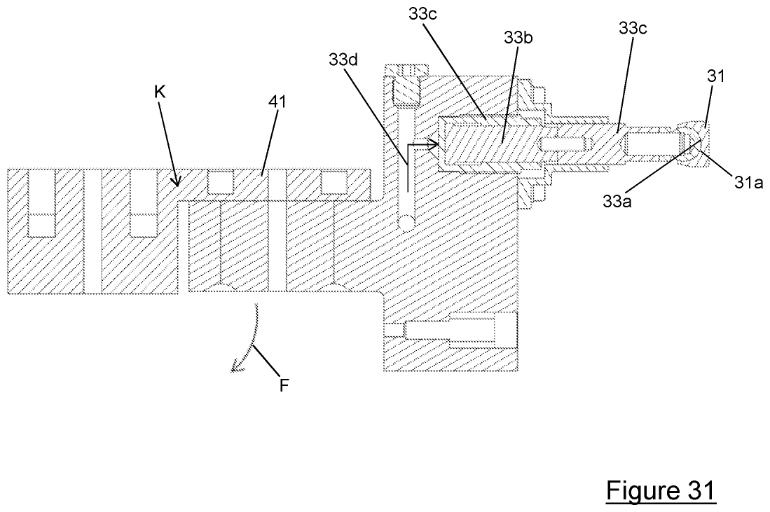

FIG. 31 is a side cut-through view of component parts of the first embodiment of the present disclosure, but with the rotor removed;

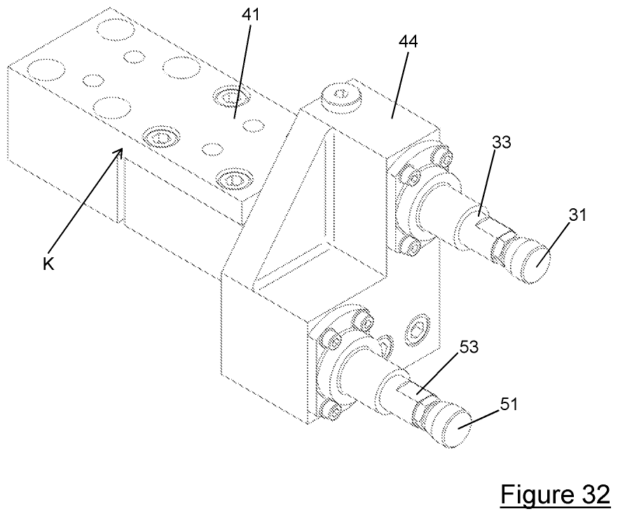

FIG. 32 is a perspective view of component parts of the first embodiment of the present, but with the rotor removed;

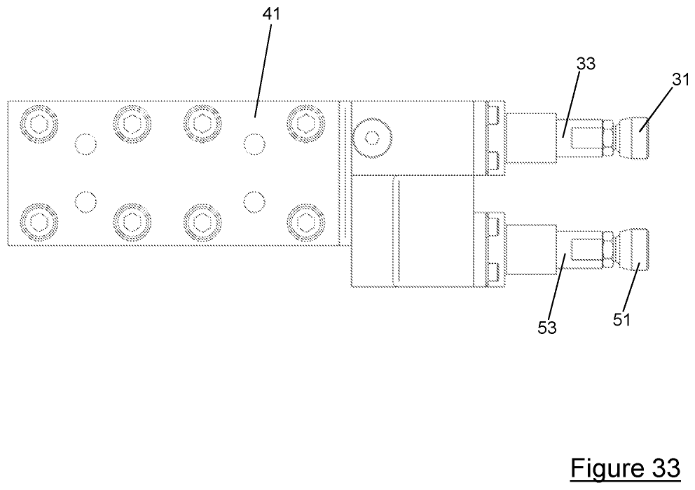

FIG. 33 is a plan view of component parts of the first embodiment of the present, but with the rotor removed;

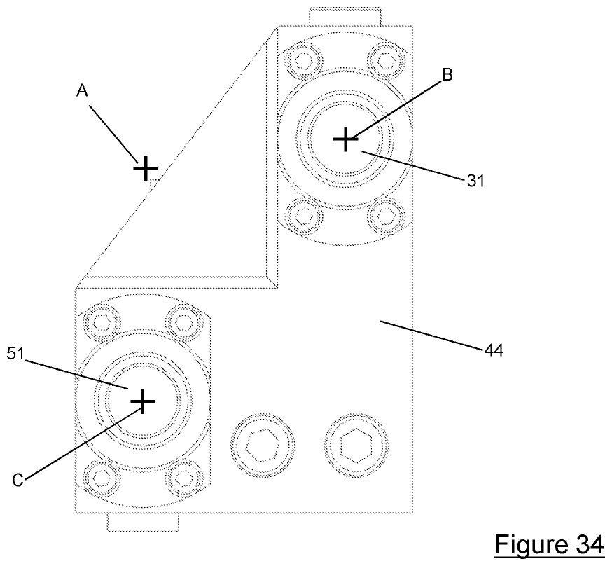

FIG. 34 is an end view of component parts of the first embodiment of the present, but with the rotor removed;

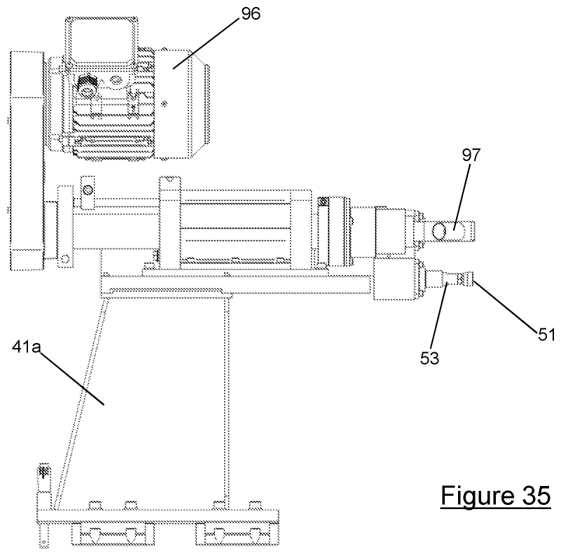

FIG. 35 is a side view of component parts of the first embodiment of the present disclosure, but with the rotor removed;

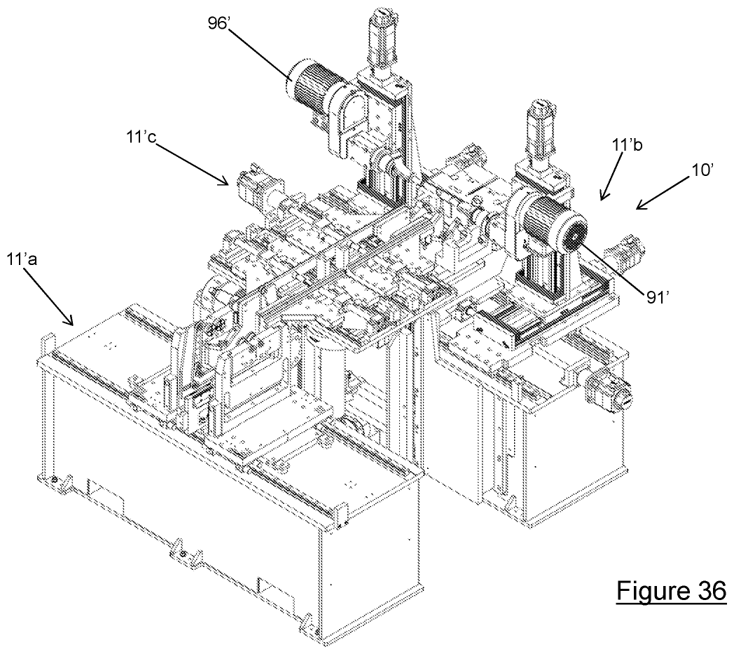

FIG. 36 is a perspective view of a second embodiment of the present disclosure;

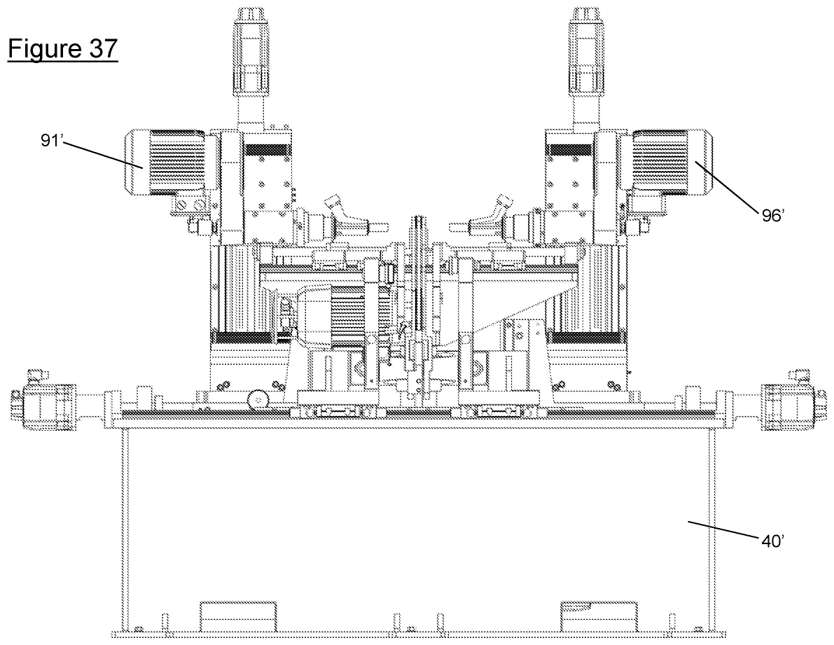

FIG. 37 is an end view of the second embodiment of the present disclosure;

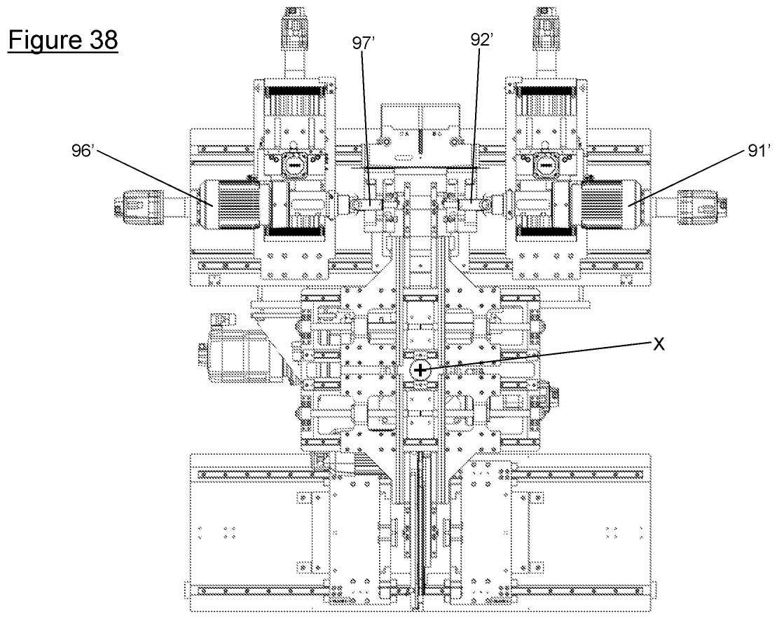

FIG. 38 is a plan view of the second embodiment of the present disclosure;

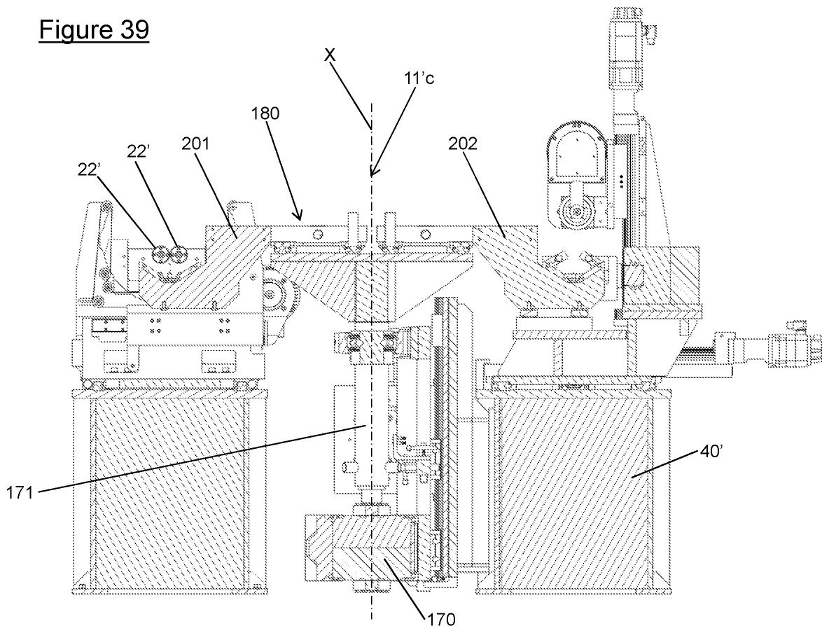

FIG. 39 is a side part cut-through view of the second embodiment of the present disclosure;

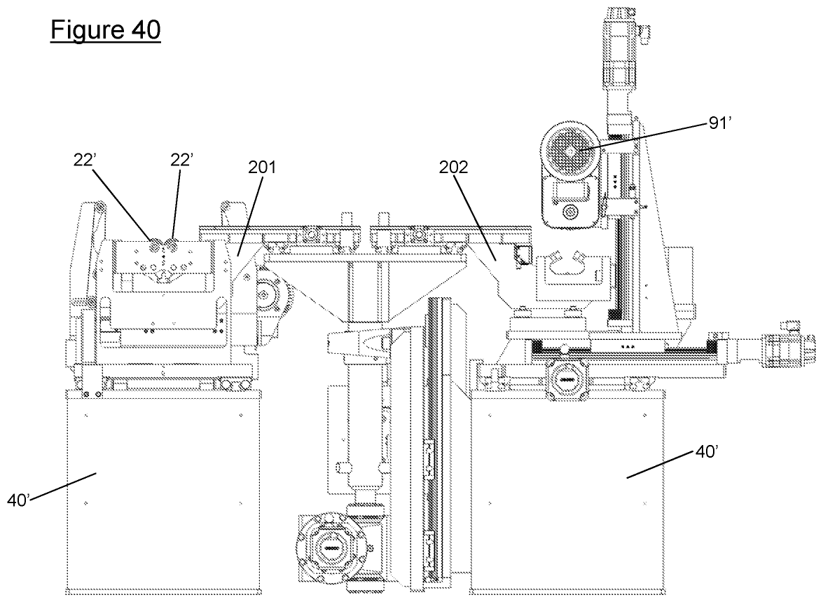

FIG. 40 is a side view of the second embodiment of the present disclosure;

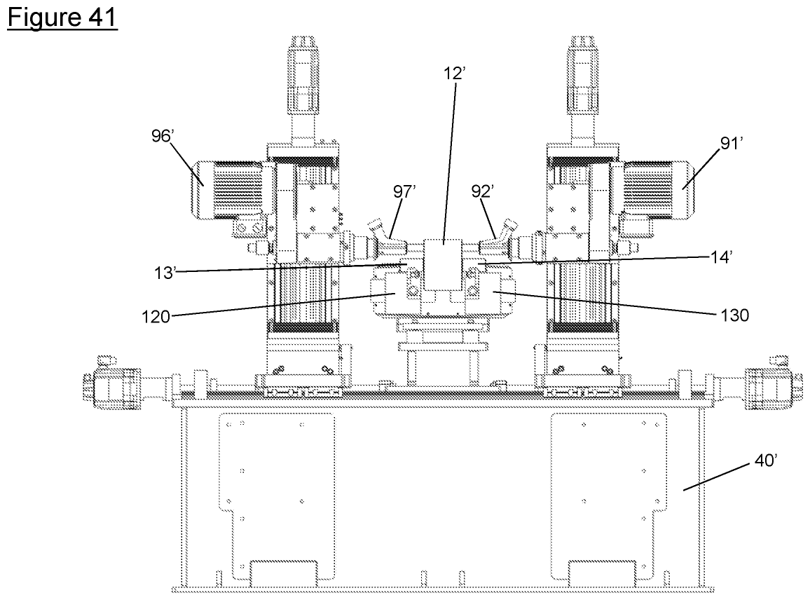

FIG. 41 is an end view of a part of the second embodiment of the present disclosure with a rotor in position;

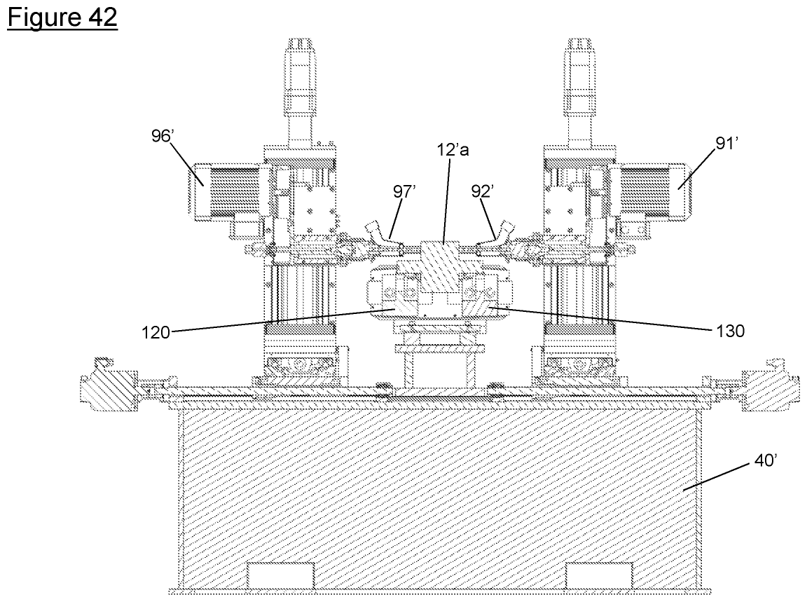

FIG. 42 is an end part cut-through view of a part of the second embodiment of the present disclosure with a rotor in position;

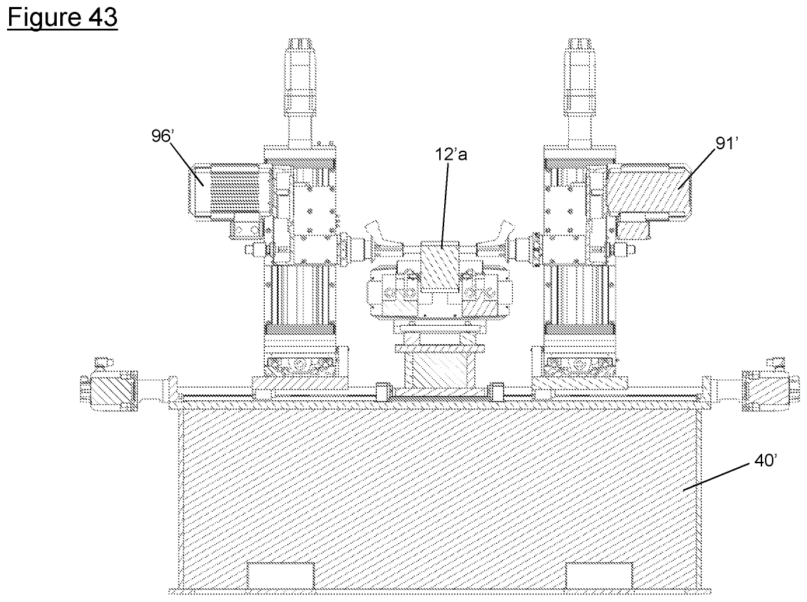

FIG. 43 is a further end part cut-through view of a part of the second embodiment of the present disclosure with a rotor in position;

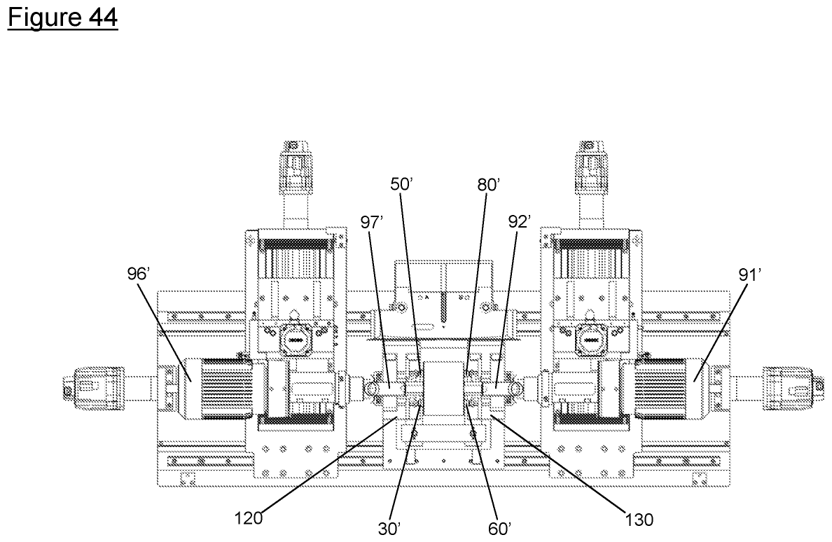

FIG. 44 is a plan view of a part of the second embodiment of the present disclosure with a rotor in position;

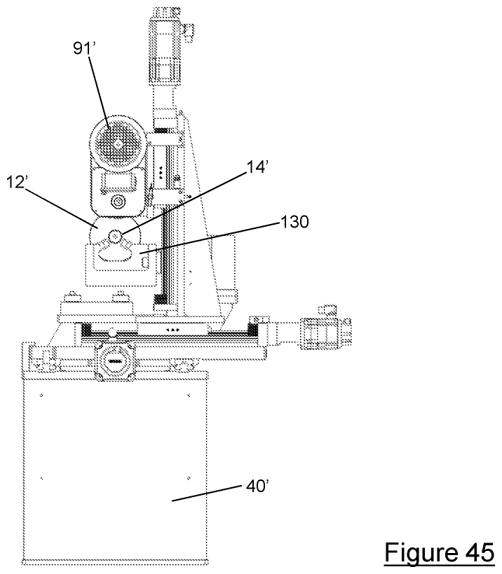

FIG. 45 is a side view of a part of the second embodiment of the present disclosure with a rotor in position;

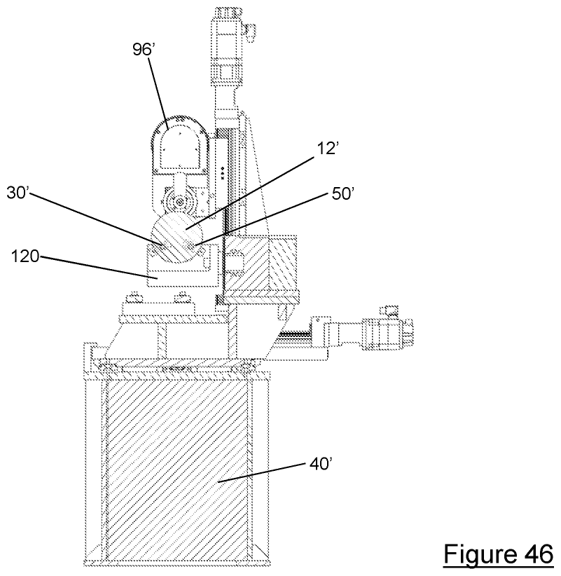

FIG. 46 is a side part cut-through view of a part of the second embodiment of the present disclosure with a rotor in position;

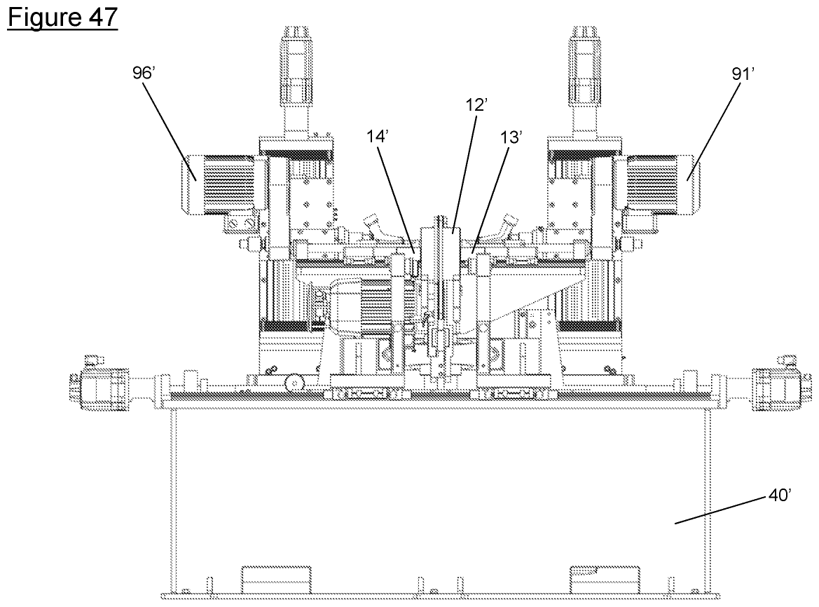

FIG. 47 is a front view of the second embodiment of the present disclosure with a rotor in position;

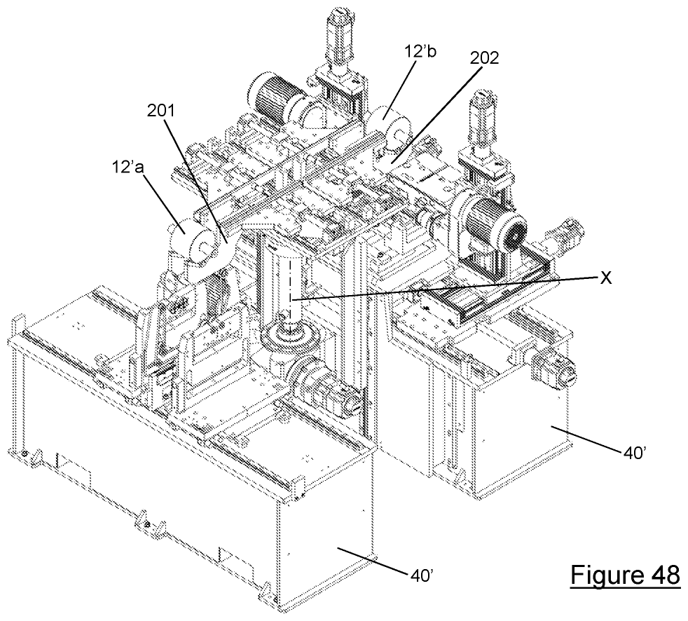

FIG. 48 is a perspective view of the second embodiment of the present disclosure showing two rotors being transferred from one part of the apparatus to another part of the apparatus;

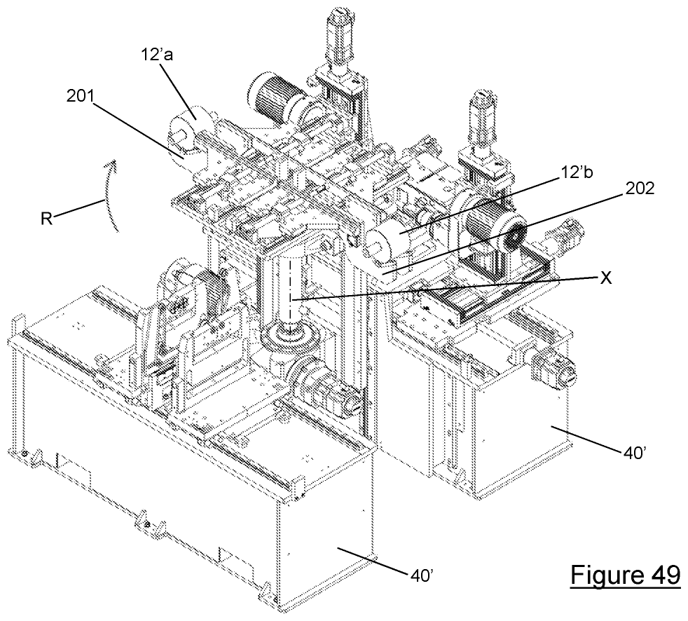

FIG. 49 is a further perspective view of the second embodiment of the present disclosure showing two rotors being transferred from one part of the apparatus to another part of the apparatus;

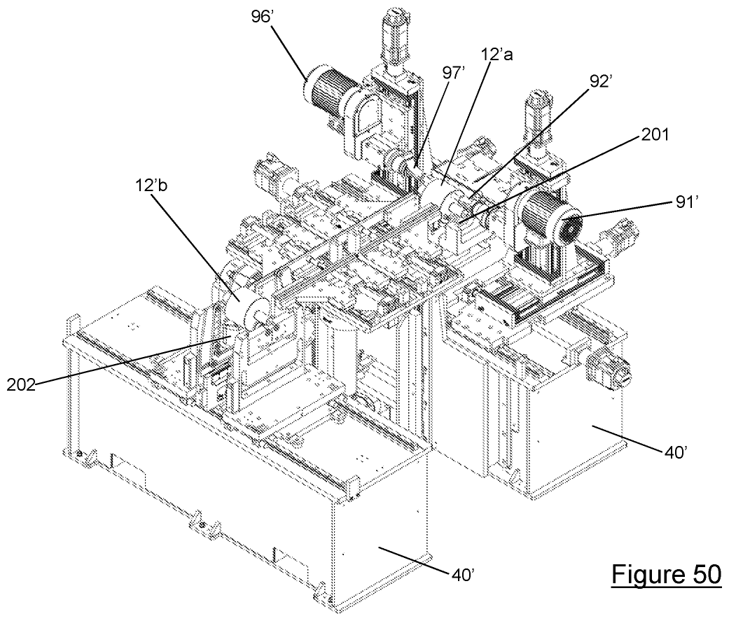

FIG. 50 is a yet further perspective view of the second embodiment of the present disclosure showing two rotors being transferred from one part of the apparatus to another part of the apparatus;

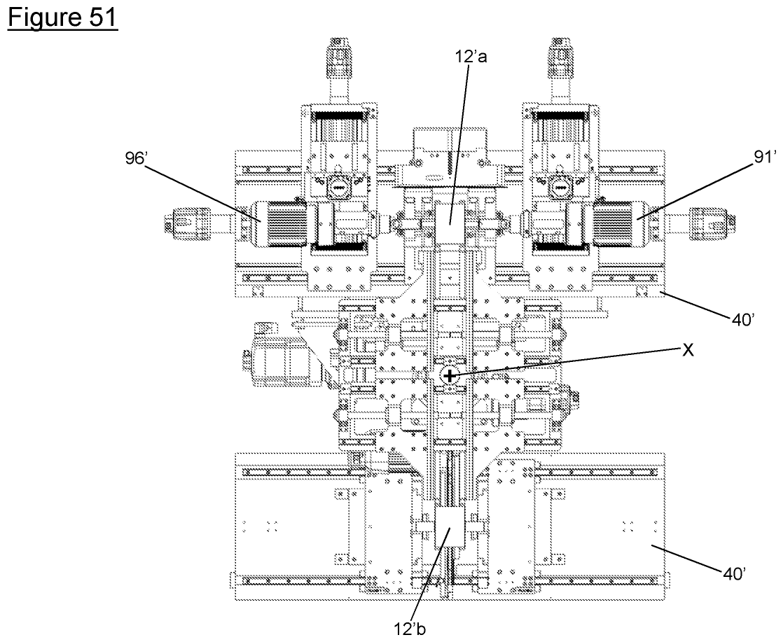

FIG. 51 is a plan view of the second embodiment of the present disclosure with a rotor in position;

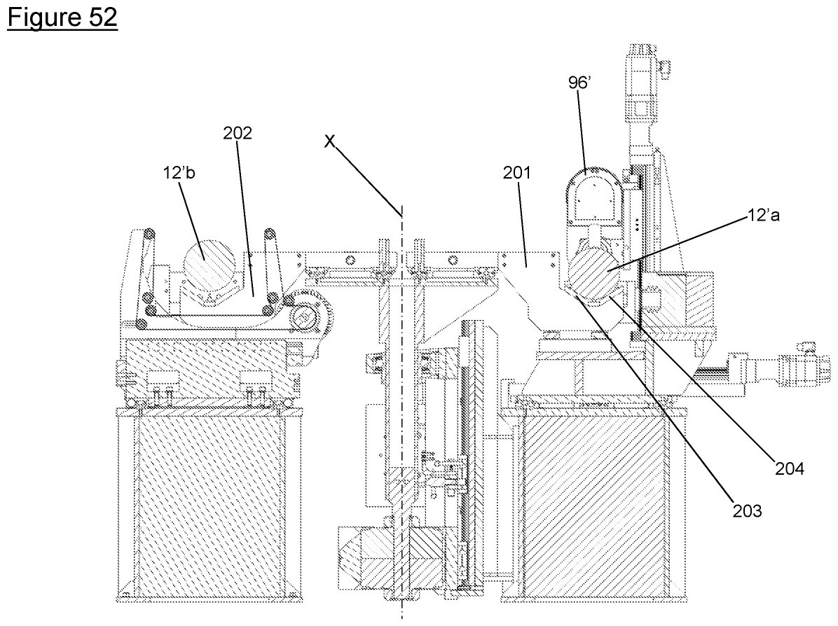

FIG. 52 is a side part cut-through view of the second embodiment of the present disclosure with two rotors in position;

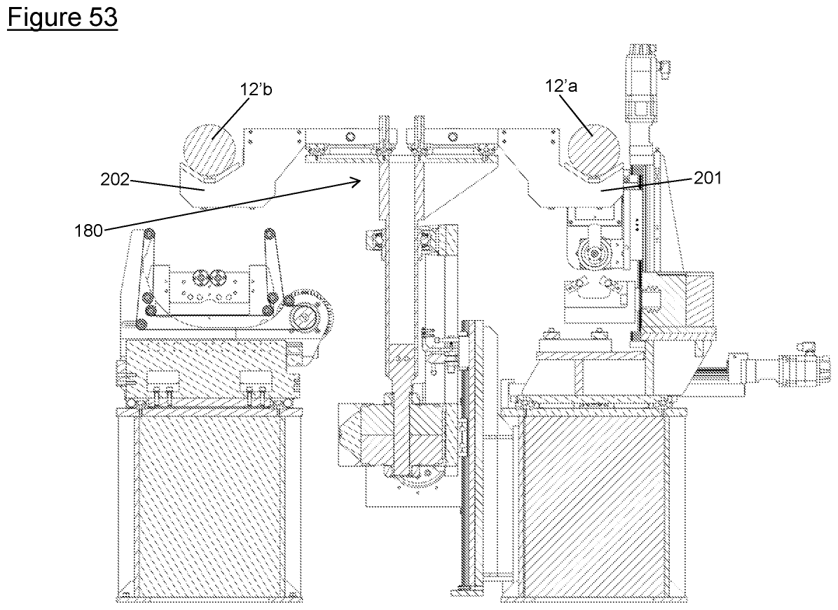

FIG. 53 is a side part cut-through view of the second embodiment of the present disclosure showing two rotors being transferred from one part of the apparatus to another part of the apparatus;

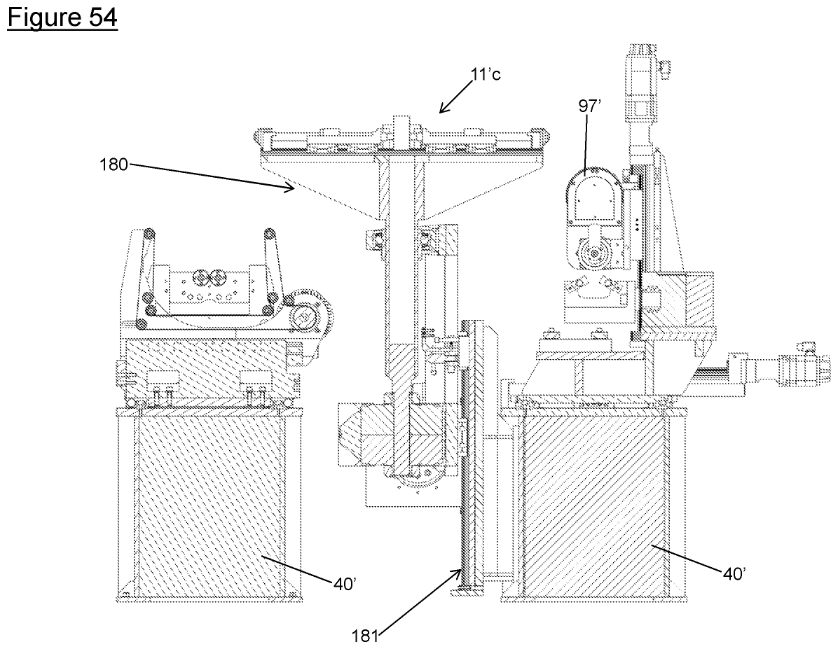

FIG. 54 is a side part cut-through view of the second embodiment of the present disclosure showing two rotors being transferred from one part of the apparatus to another part of the apparatus;

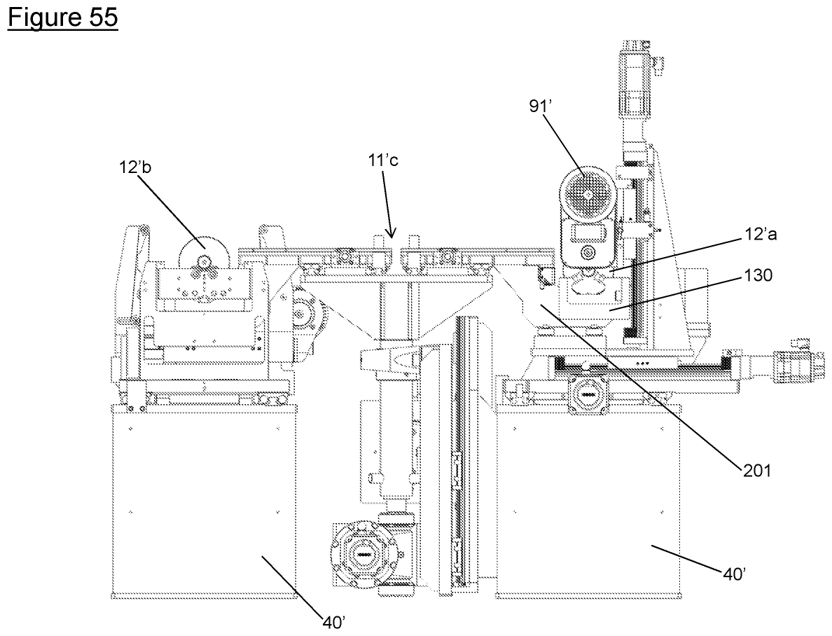

FIG. 55 is a side view of the second embodiment of the present disclosure with two rotors in position;

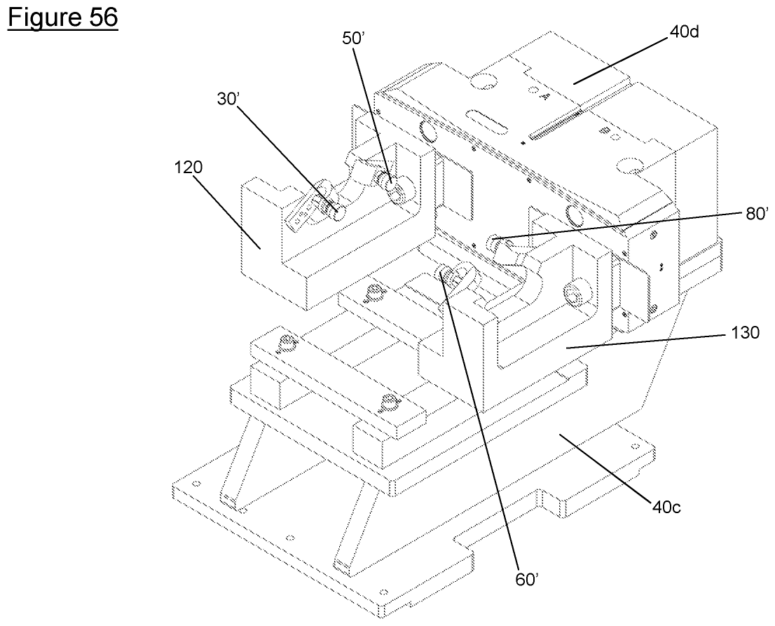

FIG. 56 is a perspective view of component parts of the second embodiment of the present disclosure, but with the rotor removed;

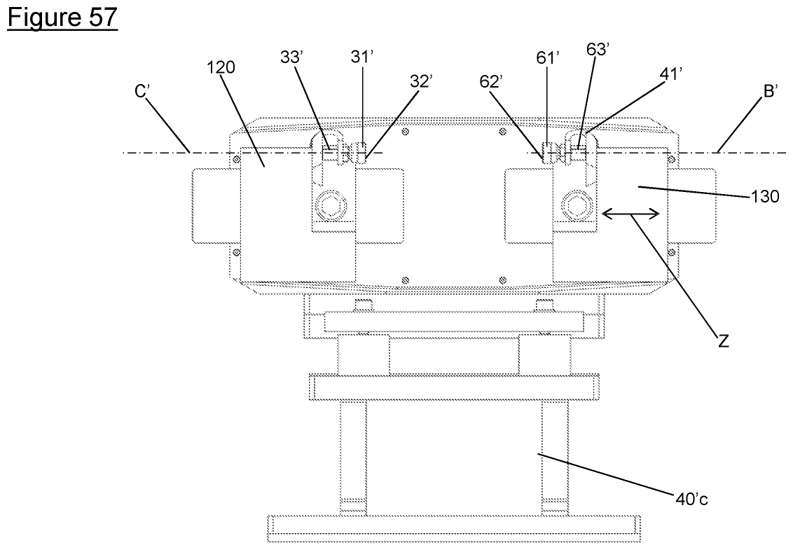

FIG. 57 is a front view of component parts of the second embodiment of the present disclosure, but with the rotor removed;

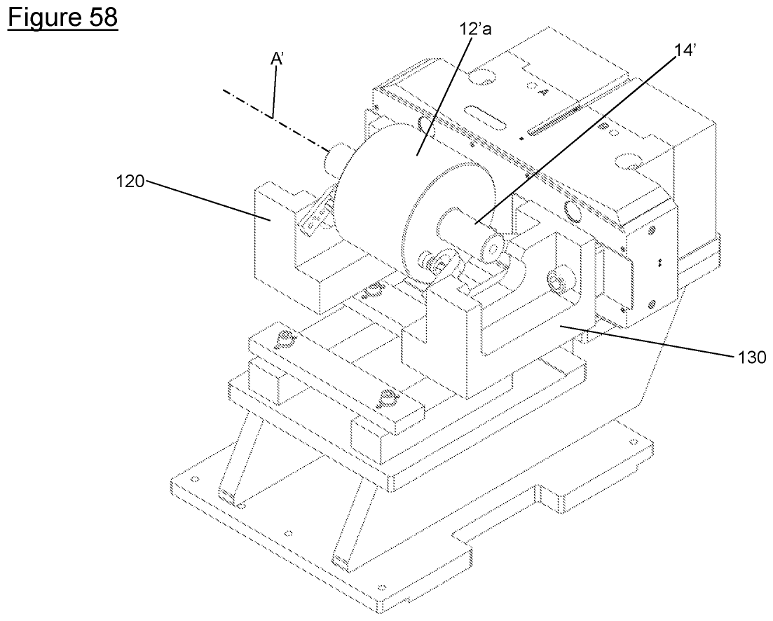

FIG. 58 is a perspective view of component parts of the second embodiment of the present disclosure with the rotor in position;

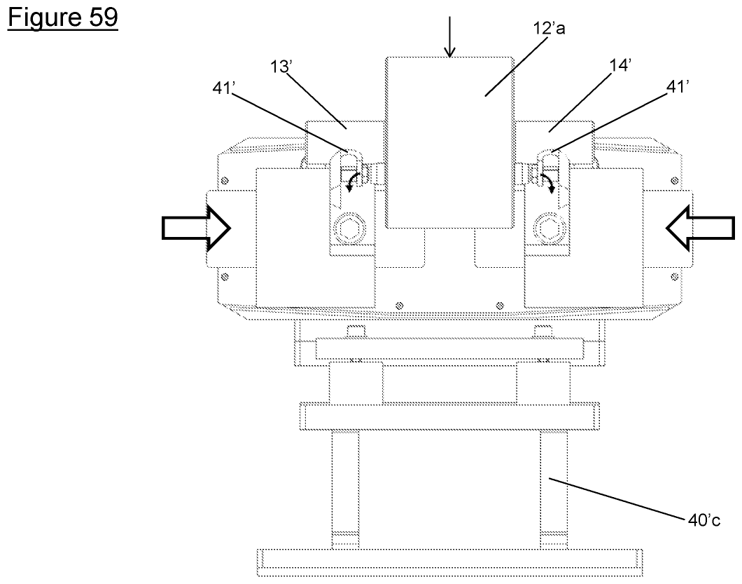

FIG. 59 is a front view of component parts of the second embodiment of the present disclosure with the rotor in position;

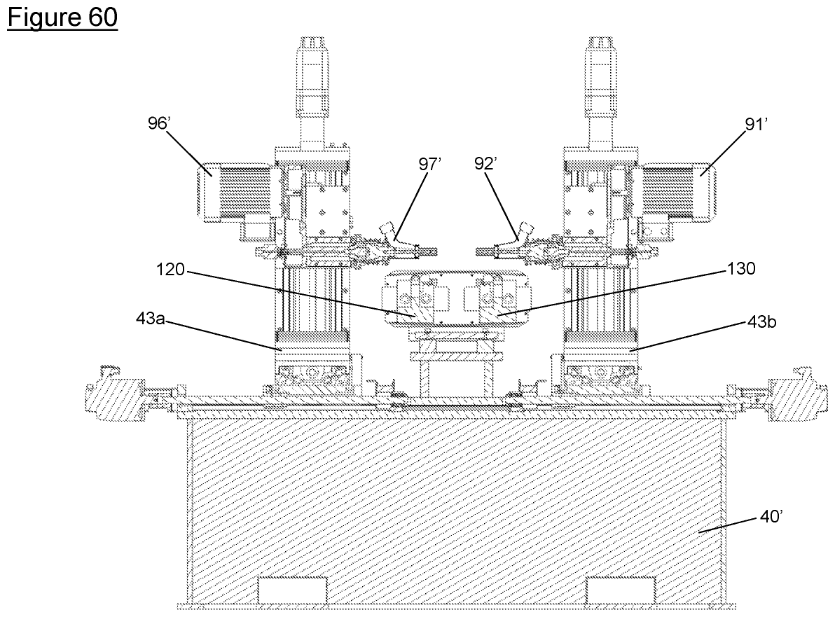

FIG. 60 is a front part cut-through view of the second embodiment of the present disclosure, but with the rotor removed;

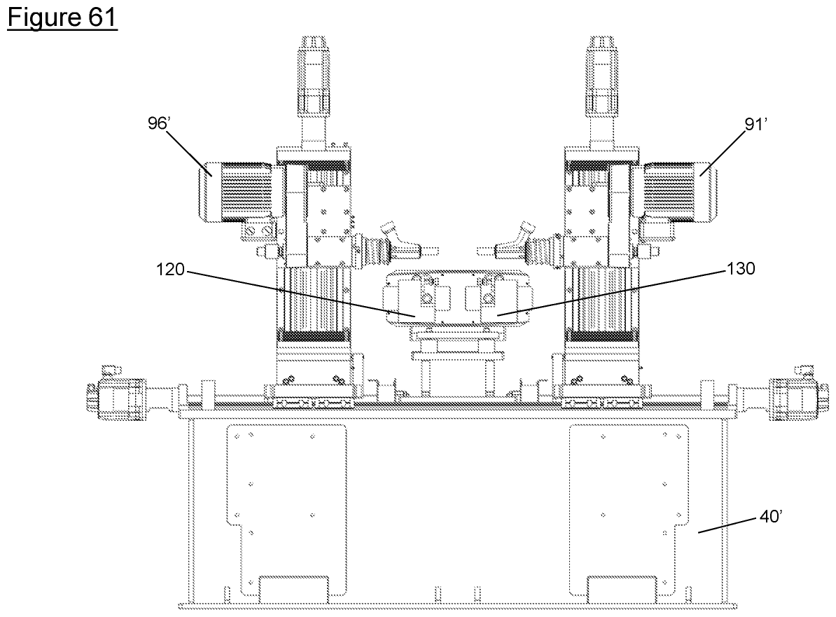

FIG. 61 is a front view of the second embodiment of the present disclosure, but with the rotor removed;

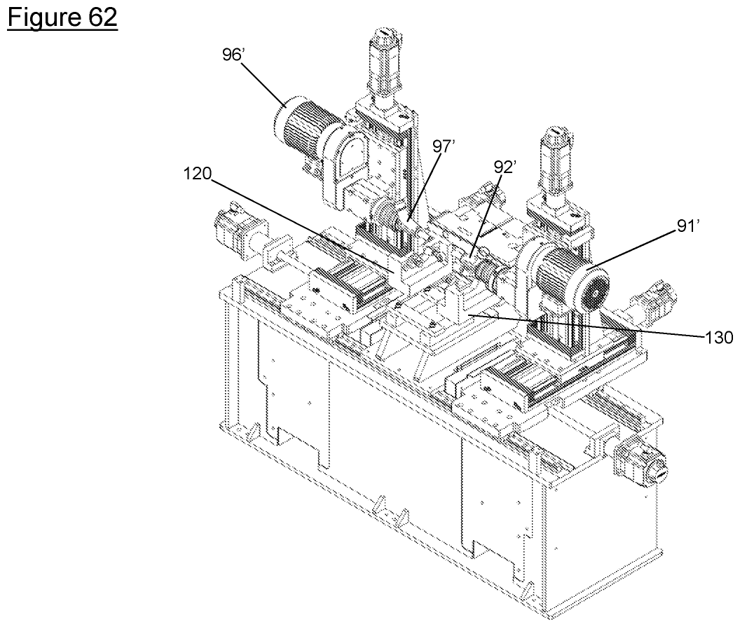

FIG. 62 is a perspective view of a part of the second embodiment of the present disclosure, but with the rotor removed;

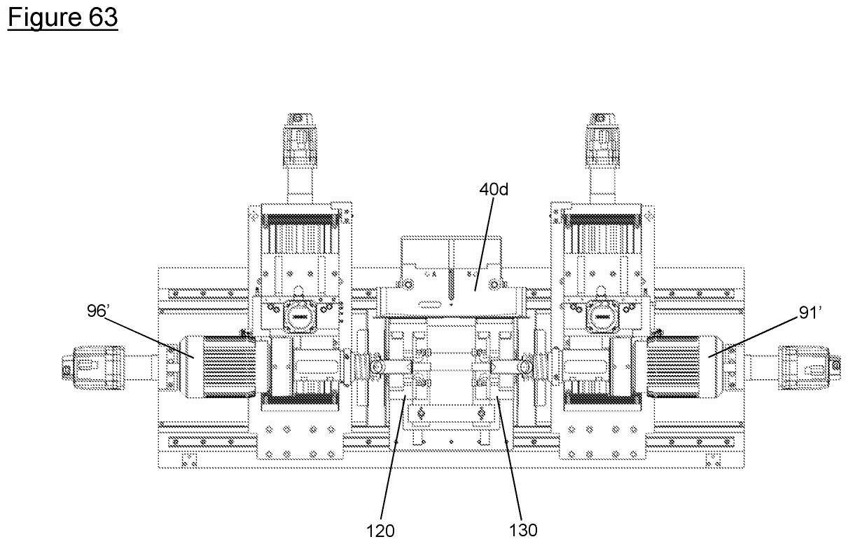

FIG. 63 is a plan view of a part of the second embodiment of the present disclosure, but with the rotor removed; and

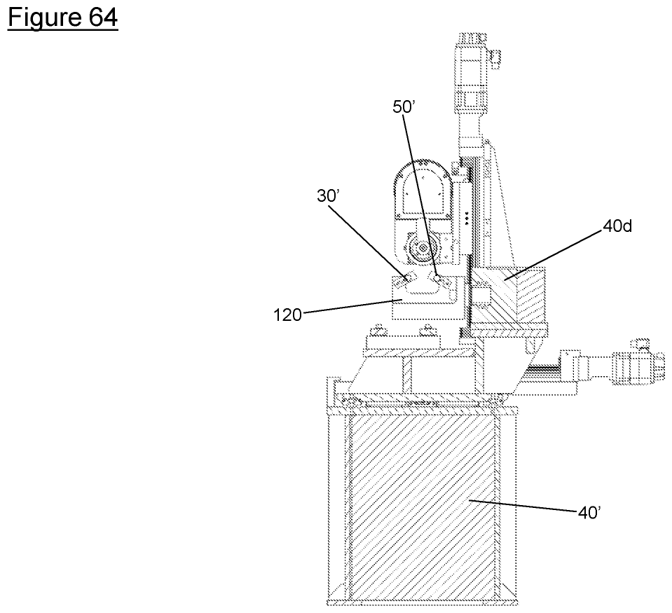

FIG. 64 is a side part cut-through view of the second embodiment of the present disclosure, but with the rotor removed.

Referring firstly to FIGS. 1 through 35, these show a first embodiment of an apparatus 10 for supporting a rotor during a balancing process. In the present embodiment, the rotor to be balanced is a rotor 12 of an electric motor, but it should be appreciated that the embodiment of the present disclosure may be used for supporting many different types of rotors, whether they are intended for electric motors or other applications.

The apparatus 10 of the first embodiment is an apparatus which is capable of both determining an amount of unbalance in a rotor and also correcting that balance to within desired tolerances. It should be appreciated though that embodiments are envisaged where the steps or process for determining the unbalance in the rotor may be conducted on a separate machine, and an example of such a disclosure is shown in the second embodiment which will be discussed later with reference to FIG. 36 or 64.

As can be seen from the Figures, the rotor 12 includes a rotor body which is generally centrally located with first 13 and second 14 rotor shaft members extending away from the rotor body at either side thereof. The rotor 12 has a rotor axis A. In embodiments, the rotor to be balanced may not be provided with integral shaft members, instead with the rotor body being provided with a bore at each side where bearings would be positioned and into which a separate shaft members would be received. In such examples, the apparatus may be provided with shaft devices to support the rotor which would be received in the bores of the rotor. Alternatively, in such examples the apparatus may be provided with small roller bearings or the like which are positionable inside the bore so as to support the inner diameter of the bore. Alternatively still an air bearing mandrel may be positionable inside the bore.

In the present embodiment, the apparatus 10 includes a support structure 40 which is typically mounted to a floor surface where the apparatus 10 is installed. The purpose of the support structure 40 is to support the components of the apparatus 10 so that the balancing process can be undertaken. It is important that the apparatus 10 is securely fastened or held relative to a floor surface to ensure that no unnecessary vibration is caused during the balancing process.

In the present embodiment the apparatus 10 includes a pair of support devices 20, 21 for supporting the first 13 and second 14 rotor shaft members. Each support device 20, 21 includes a pair of rotatable rollers 22 which are mounted via appropriate bearings and which are spaced from each other and rotatable about axes which are parallel to the rotational axis A of the rotor. In the present embodiment, the rotatable members 22 are positioned below the rotor axis A, e.g. closer to the floor surface which supports the apparatus 10, such that the rotor 12 rests on top of the rollers 22. In particular, in embodiments the rotatable members 22 may be positioned such that their axes of rotation are in a generally horizontal plane below that containing the rotor axis A. The rotatable members 22 are passively rotatable in this example, with the rotor 12 being driven by separate means (discuss later). However, in embodiments the rotatable members 22 may be driven to rotate such that they can effect rotation of the rotor 12 about its rotor axis A.

In examples, one or more air bearings may be used instead of the rollers 22. For example the air bearing may be a half cup that the rotor shaft engages and air may be forced through holes in the half cup so an air layer is provided between the cup and rotor shaft. Other methods of supporting the rotor shaft members may be employed.

In order to determine whether and to what extent the rotor 12 is unbalanced, the apparatus 10 to be able to rotate the rotor 12 about its rotor axis A at or near its typical in use rotational speed. The apparatus, therefore, includes one or more devices for sensing or determining an amount of unbalance in the rotor at one or more balancing claims thereof, as well be known in the art (not shown). In order to effect rotation of the rotor 12 about its rotor axis A, the apparatus 10 includes a device 100, which is a belt-drive system including one or more flexible belt members 110 which is/are supported by way of a pair of upwardly extending arm structures 102, 103. The arms 102, 103 each support a plurality of rollers around which the belt(s) 110 passes. The arms 102, 103 are supported by a movement mechanism powered by a suitable motor or the like to effect movement of each arm towards the rotor 12, thereby sandwiching the rotor in between the arms 102, 103. A motor 105, supported by the support structure 40, then effects movement of the belt 110 along its entrained path and by virtue of the belt engaging the peripheral surface of the rotor body causes the rotor 12 to rotate about its rotor axis A. Whilst rotating, the unbalance in the rotor 12 is determined, as is known in the art.

In the present embodiment the rotor 12 is balanced (i.e. unbalance is corrected) by removing material from the rotor body. In this particular embodiment the rotor 12 is provided with rotor body portions which are provided solely so that material may be removed therefrom as part of the balancing process. The body portions are provided at respective actual end faces of the rotor body and in this example are disc shaped or angular with the central aperture which is fitted over the respective rotor shaft member 13, 14 by an interference fit. Whilst it is desirable for the axial end faces of these rotor body portions to be parallel with each other (i.e. perpendicular to the rotor axis A), it is often the case that they are not sufficiently parallel once installed or not sufficiently flat/planar on their exterior surface, which can lead to problems during the balancing process.

In order to remove material from these rotor body portions, the apparatus 10 is provided with a plurality of holding devices for holding the rotor 12 in position whilst respective drilling devices 90, 95 (discuss later) are employed to remove material from the rotor body portions. Holding the rotor 12 securely whilst drilling is undertaken improves the quality and therefore accuracy of the drilling stage and prevents or at least minimises the likelihood of burr remaining at the entrance of the drilled bore, which can lead to material remaining connected to the rotor body which will detrimentally affect the balance of the rotor 12. As an alternative to the drilling devices shown in the figures (which drill straight bores of material), the apparatus may include flat bottom drilling and milling, where arcuate cuts of material are removed to achieve balancing of the rotor.

In the present embodiment, the rotor is sandwiched between opposing pairs of holding devices 30, 50, 60, 80, the details of which will be discussed in more detail below. The holding devices 30, 50, 60, 80 are similar to one another in terms of their construction and operation.

As can be seen from the Figures, supported on top of the support structure 40 are respective sub structures 41a, 41b. The support of the sub structure 41a is moveably supported on an upper surface of the support structure 40 and provides support for first 30 and third 50 holding devices and a first drilling device 95. Positioned opposite the sub-structure 41a is the sub-structure 41b which supports second 60 and fourth 80 holding devices and a second drilling device 90.

The first drilling devices 95 includes a drill bit 97 which is supported for rotation about an axis which is parallel to the rotor axis A (and preferably in the same horizontal plane as axis B) and is driven by an electric motor 95 via appropriate gearing. The opposite side of the apparatus 10 includes a second drilling device 90 which again includes a respective drilling bit 92 supported again for rotation about an axis which is parallel to the rotor axis A and which is driven by an electric motor 91 via appropriate gearing. It should be appreciated that each side of the apparatus 10 could be provided with multiple drilling devices as required or desired. It should also be appreciated that the drilling devices may have axes which are inclined at an angle to the rotor axis A, if desired.

In the present example, the drilling devices 95, 90 are positioned such that their axes are above the rotor axis A, but embodiments are envisaged where they are positioned elsewhere, e.g. level with or below the rotor axis A.

It should be appreciated that each drilling device 95, 90 may be provided with an extraction mechanism to extract away from the drilling area any removed material e.g. by connecting the drilling device to a source of suction. Such mechanisms are well known in the art.

Referring particularly to FIGS. 21 to 34, these show close up views of the sub-structure 41a and the first 30 and third 50 holding devices supported thereby. As can be seen from the Figures, each holding device includes a respective abutment member 31, 51 for engaging, in use, with the respective axial end face of the rotor body 12. In particular, each abutment member 31, 51 includes a respective, preferably planar, abutment surface 32, 52 which engages the axial end faces 13a, 14a of the rotor body 12. Advantageously, the angle of the abutment surface 32, 52 relative to the rotor axis A is moveable.

Each abutment member 31, 51, is supported and connected to an end of a respective projecting member 33, 53 by a gimbal-type joint. This is provided by way of a part spherical end 33a, 53a of the projecting member 33, 53 which is received in and engages with a part spherical inner surface 31a, 51a of the abutment member 31, 51. This moveable connection permits the angle of the abutment surface 32, 52 to move relative to the rotor axis A. In other words, as can be seen in FIG. 30, the angle Y with which the surfaces 32, 52 intersect the rotor axis A is not fixed but is moveable. This permits the abutment members 31, 51, to move so as to account for any angle of inclination of the end face 13a of the rotor body 12 relative to the axis A. Such angles of inclination may be present as a result of the axial end faces 13a, 14a not being parallel with each other.

It should be appreciated that whilst a gimbal-type joint has been provided at the connection between the abutment member 31, 51 and its a respective projecting member 33, 53, other suitable types of connection may be provided so long as they permit for the abutment surface 32, 52 to be moveable relative to the rotor axis A.

As can be seen from the Figures, each holding device 30, 50 is hydraulically operable such that the abutment member 31, 51 is moveable towards and away from the rotor 12 so as to engage with the axial end face 13a, 14a. This is achieved in this example by providing a piston/cylinder arrangement whereby a portion 33b, 53b of the projecting member 33, 53 is received in a cylinder 33c, 53c, with the interior space of the cylinder being connected to a hydraulic line 33d, 53d. An increase in hydraulic fluid pressure moves the projecting members 33, 53 towards the rotor 12, and a decrease in hydraulic fluid pressure moves the projecting members 33, 53 to away from the rotor 12. In this particular example, there is a common passage for hydraulic fluid connecting the cylinders 33c, 53c, such that they move in synchrony, but it should be envisaged that separate hydraulic lines and sources may be provided with the holding devices 30, 50 therefore being operated independently. As an alternative to hydraulic operation, the projecting members may be moveable by electrically operated servo devices, pneumatic piston/cylinder arrangement(s) or any other suitable means of achieving the desired movement thereof.

As can be seen from the Figures, the configuration of the abutment members 31, 51 are such that the respective abutment surfaces 32, 52 align passively with a plane of the actual end face 13a, 14a of the rotor body as and when they touch.

Referring in particular to FIG. 29 it will be seen that the first 30 and third 50 holding devices are supported by way of a part 44 (which includes the conduits for the hydraulic fluid) which is connected to an underside of a support part 41. The support part 41 is in turn connected to the support sub structure 41a and is configured such that the part 41 is deformable in preference to many of the surrounding components. This means that the part 41 is configured preferentially to deform, in use at a position or location K, which in this particular example is positioned at or below the rotor axis A. This configuration of the deformable part or member 41 ensures that as the holding devices 30, 50, 60, 80 engage the respective axial end faces 13a, 14a of the rotor 12 (sandwiching the rotor in between), a resulting force F applied to the axial end faces urges the rotor 12 downwardly towards the ground surface and in particular urges the respective rotor shaft members 13, 14 downwardly towards their respective support devices, namely the rollers 22. This downward force F means that the rotor 12 is held securely in position prior to the drilling stage so as to ensure or at least minimise any vibration which may occur as part of the drilling process.

In more detail, because the deformable member 41 deforms or bends downwardly during use, this has the effect of causing the respective projecting members 33, 53, 63, 83 to pivot downwardly towards the rollers 22. However, because the abutment members 31, 51, 61, 81 are configured to move relative to their respective projecting members, the rotor 12 is continued to be held firmly between the first 30 and third 50 holding devices to one side of the apparatus and the second 60 and fourth 80 holding devices to the opposite side of the apparatus 10.

As can be seen from the figures, in particular FIG. 34, an axis B of first holding device 30 is positioned slightly above the horizontal plane in which the rotor axis A sits, with an axis C of the third holding device 50 being positioned substantially vertically below the rotor axis A. In other embodiments, it is envisaged that the holding devices and their respective abutment members may be positioned elsewhere relative to the rotor axis A. In particular, for example, they may be positioned laterally to each side of the rotor axis A, with one or both of the abutment members being positioned above or below the rotor axis A. However, they are advantageously positioned in the configuration shown in FIG. 34 to provide room for the respective drilling devices 97, 92.

As can be seen in many of the figures, the second 60 and fourth 80 holding devices take the form of substantially mirror images of the respective first 30 and third 50 holding devices, and thus their component parts and operation will not be discussed in further detail herein, except to say that they may be provided connected to the same hydraulic source which effects movement of the first and third abutment members or they may be connected to a separate hydraulic source. Thus, all four abutment members 31, 51, 61, 81 may move synchronously towards and away from the rotor 12 when effecting holding of the rotor 12. Alternatively, the apparatus 10 may be configured so as to cause the abutment members 31, 51 firstly to engage the axial end face 13a, with the abutment members 61, 81 engaging the axial end face 14a afterwards. Alternatively still, the apparatus 10 may be configured so as to cause the abutment members 61, 81 firstly to engage the axial end face 14a, with the abutment members 31, 51 engaging the axial end face 13a afterwards. Of course, embodiments are envisaged where the apparatus engages one abutment members 31, 51, 61, 81 at a time or one abutment members 31, 51, 61, 81 from each side at the same time.

In the present example, the first abutment member 31 and the second abutment member 61 are position substantially opposite each other either side of the rotor 12, with the third abutment member 51 and fourth abutment member 81 also being positioned substantially opposite each other either side of the rotor 12. However, embodiments are envisaged where the abutment members are not positioned directly opposite each other.

Also, whilst in the present embodiment the apparatus 10 includes two holding devices positioned at each side of the rotor 12, embodiments are envisaged where only one holding device is provided at each side of the rotor 12 or more than two holding devices are positioned at each side of the rotor 12. In other embodiments, it is envisaged that an even number of holding devices may be positioned to one side of the rotor 12, with an odd number of holding devices being positioned to the opposite side of the rotor 12.

Also, whilst it is shown in the present embodiment 10 that the apparatus 10 is capable of measuring the unbalance of the rotor 12 and then also effecting removal of material from the rotor 12 so as to correct the unbalance, embodiments that are envisaged where the determining of the unbalance is carried out on a separate device or apparatus with the rotor then being transferred to the apparatus 10 for drilling to be undertaken.

It should also be noted that whilst in the present embodiment the first 95 and second 90 drilling devices are positioned substantially opposite each other at either side of the rotor body and along a common axis, they need not necessarily be positioned in that location and may be positioned offset from one another or positioned at any desired position around the rotor axis A. Also, embodiments are envisaged where each drilling device is moveable relative to the rotor such that the location of drilling can be modified. In the present example, the location of drilling is effected by the rotation of the rotor 12, so that the location of the desired drilling is aligned with the fixed location of the drilling device. However, in embodiments, the rotor 12 may not be rotated and instead the drilling device(s) moved.

Referring to FIGS. 36 to 64, these show a second embodiment of the present disclosure. Features which are the same or substantially the same in construction, configuration, and/or operation have been given the same reference numerals as used in the disclosure of FIGS. 1 to 35, but with the addition of a prime symbol (′).

The apparatus 10′ as shown in these figures is a two stage apparatus having a first station 11′a, a second station 11′b and a transfer station 11′c positioned therebetween. The first station 11′a is utilised for supporting a rotor 12′ about is rotor axis A′ and for determining an amount of unbalance in the rotor. The station 11′c is then used to transfer said rotor 12′ to the station 11′b where the determined unbalance is corrected by utilising a pair of drilling devices to remove material from either side of the rotor 12′.

It should also be appreciated that whilst the apparatus 10′ shows the stations 11′a, 11′b and 11′c as connected to and/or positioned next to one another, this need not be the case. Indeed, embodiments are envisaged where the unbalance measuring of station 11′a is positioned elsewhere and the rotor is then transferred to the station 11′b by a means other than the shown station 11′c.

In any event, it can be seen from the figures that the station 11′c includes a rotatable and vertically moveable rotor support structure 180 which is rotatable about a vertical axis X. The structure 180 includes by a motor 170 (with appropriate gearing) and a driven shaft 171 which is vertically aligned. Connected to an upper end of the shaft 171 and extending radially away from the shaft are a pair of opposing arms 201, 202 for supporting a pair of rotors 12′. The rotor support structure 180 is connected to and vertically translatable relative to a support structure 40 which is typically mounted to a floor surface where the apparatus 10′ is installed.

The opposing arms 201, 202 are diametrically opposed either side of the axis X. Each support arm is provided at its distal end with a pair of inclined surfaces 203, 204 (as best seen in FIG. 52) to support a respective rotor 12′a, 12′b. These surfaces 203, 204 provide a support cradle for the body of the rotor 12′ during the transfer of the rotor 12′ from the station 11′a to the station 11′b. The position of each set of surfaces 203, 204 relative to the axis X may be moveable but suitable means, so as effective to alter the radial positions thereof. As compared with the first embodiment discussed earlier, during the drilling process at station 11′b, the rotor 12′ is supported by the surfaces 203, 204 against the underside of the body, rather than its rotor shaft members being supported (as was the case with the first embodiment). However, embodiments are envisaged where the arms 201 are configured to support the shaft members of the rotor 12′.

The station 11′b of the apparatus 10′ includes the support structure 40′ which is connected to or held relative to the floor surface. An upper surface of the support structure 40′ supports the component parts for attending to the removal of material from the rotor 12′ to correct for any unbalance.

As mentioned previously, the second embodiment shares many of the functional and constructional attributes of the first embodiment of this disclosure, notably the provision of a first, second, third and fourth 30, 50, 60, 80 holding devices positioned two to each side of the rotor 12′a which operate to hold the rotor 12′a in position for drilling. The holding devices are supports by a structure 40d and will be discussed in more detail later.

The station 11′b includes first and second drilling devices 95′, 90′, positioned opposite each other and one to each side of the support 40a. The first and second drilling devices 95′, 90′ are mounted to respective supports 43a, 43b which are moveable towards and away from each other along a top surface of the support structure 40′. The drilling devices 95′, 90′ provide for removal of material from respective axial end portions of the rotor body in order to correct for any unbalance in the rotor.

The drilling devices 95′, 90′ and their respective drill bits 97′, 92′ are moveable relative to the rotor axis A such that the location of drilling can be modified. This is important in the present embodiment, as the rotor 12′ is not able to be rotated once supported by the arm 201, 202. In the embodiments, the rotor 12′ may be rotatable at the station 11′b and instead the drilling device(s) may be fixed relative to the support 40′.

It should also be noted that whilst in the present embodiment the first 95′ and second 90′ drilling devices are positioned substantially opposite each other at either side of the rotor body, they need not necessarily be positioned in that location.

As mentioned previous, the holding devices are supports by a structure 40d which is fixed to an upper surface of the support structure 40′. The first 30′ and third 50′ holding devices are positioned to one side of the rotor body and are configured to engage the axial end face 13′a thereof. The opposite side of the station 11′b is provided with second 60′ and fourth 80′ holding devices which are configured for engaging with the axial end face 14′a of the rotor 12′a. The structure 40d is best shown in FIGS. 56 to 59 and for clarity the surfaces 203, 204 have not been shown.

In a similar configuration to the first embodiment of this disclosure, each holding device includes a respective abutment member 31′, 51′, 61′ 81′ which is connected to a respective projecting member by way of a gimbal-type joint which permits the abutment member to rotate and incline its abutment surface 32′, 52′, 62′, 82′ relative to an axis of the projecting member 33′, 53′, 63′, 83′ and the rotor axis A′. Whilst in the first embodiment of this disclosure the projecting members were connected preferably by way of hydraulic piston/cylinder arrangements in order to effect movement of the abutment surface towards and away from the axial end face 13′a, 14′a of the rotor 12′, in the second embodiment of this disclosure, the first and third holding devices are supported on a first fixed arm 120 which is held relative to a support structure 40d and does not move relative thereto. The second and fourth holding devices are supported by a second arm 130 which is connected to the support structure 40d but which is slidably moveable in the direction of arrow Z, preferably in a generally horizontal direction) towards and away from the first arm 120 by a hydraulic piston/cylinder arrangement (not shown, but contained with the body of the part 40d). Again, the second arm 130 may be moveable by other means, e.g. by an electrically operated servo device, pneumatic piston/cylinder arrangement or any other suitable means of achieving the desired movement thereof.

This arrangement ensures that the second and fourth abutment members are movable collectively towards and away from the first and third abutment members so as to sandwich the rotor body there between. As shown in the figures and in particular with reference to FIG. 57, the projecting member of each holding device is connected to its respective arm 120, 130 by a substantially n-shaped deformable member 41′. The deformable member 41′ is connected at one end to the respective arm 120, 130 where it then extends upwardly and, via a curved portion, towards the rotor. A free end of the member 41′ (which is positioned closest to the rotor 12′) extends downwardly and at this free end it supports the projecting member 33′, 53′, 63′, 83′. The n-shaped member 41′ is effectively inclined at an angle relative to a vertical plane which intersects the rotor axis A′. Therefore, the member 41′ supporting the first projecting member and the member 41′ supporting the second projecting member are inclined in the same direction upwardly and away from the part 40d. The member 41′ supporting the third projecting member and the member 41′ supporting the fourth projecting member are also inclined in the same direction as each other but upwardly and towards the part 40d.

The deformable member 41′ is configured such that as the abutment surfaces 32′, 52′, 62′, 82′ of the abutment members engage the axial end faces of the rotor 12′, the upper curved portion of each deformable member 41′ flexes and deforms effectively causing the projecting members each to pivot downwardly towards the support surfaces 203, 204. This, in turn, urges the rotor body further into engagement with those surfaces 203, 204 so as to securely hold the rotor body for the drilling procedure.

As can be seen from the figures, in particular FIG. 57, the first and third holding devices, and their respective abutment members, are spaced from each other substantially evenly either side of the vertical plane which extends through the rotor axis A′. In similar fashion, the second and fourth holding devices and the respective abutment members are also spaced from each other substantially evenly either side of a vertical plane which extends through the rotor axis A′. In this particular embodiment, the axes of the first and second projecting members are coaxial. Furthermore, the axes of the third and fourth projecting members are also coaxial with each other. However, embodiments are envisaged where the axes of the opposing projecting members are not so aligned.

The first arm 120 supports the first and third holding devices at a position such that the abutment surface of the first abutment member is positioned closer to the first axial end face of the rotor 12′ than the abutment surface of the third abutment member. Likewise, the second arm 130 supports the second and fourth holding devices such that the abutment surface of the second abutment member, is positioned closer to the second axial end face of the rotor 12′ than the abutment surface of the fourth abutment member. This ensures that as the second arm 130 is moved in the direction Z towards the first arm 120, so as to sandwich the rotor 12′ therebetween, the first and second abutment members, in most examples, engage with the respective axial end faces of the rotor 12′ slightly before the third and fourth abutment members engage with the axial end faces of the rotor 12′. This has the advantage that all four abutment members should engage with the axial end faces of the rotor 12′ during the holding operation, i.e. prior to drilling.

Once the apparatus 10′ is holding the rotor 12′a in position, the drilling operation can occur. Once this has been completed, the station 11′c operates to lift the rotor 12′a away from the station 11′b, rotate the structure 180 and then deliver a new rotor 12′b (which and been measured for unbalance) to be drilled.

It will be appreciated by those skilled in the art that the apparatus 10, 10′ will require, for examples, electrical cabling/conduct/ducting and/or hydraulic or other fluid pipework so as to connect the various components to each other so that they may be operated as desired. For clarity, such cabling and pipework has been omitted from the figures, so as not to obscure the important components parts of the apparatus.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. An apparatus for supporting a rotor during a balancing process, said rotor including a rotor body and preferably first and second rotor shaft members positioned at either side of the rotor body, the apparatus including:
one or more support devices for supporting the rotor and/or one or both shaft members thereof;
a first holding device including a first abutment member for engaging, in use, with a first axial end face of the rotor body,
a second holding device including a second abutment member for engaging, in use, with a second axial end face of the rotor body,
wherein the first and second abutment members each include an abutment surface which in use engages the respective axial end face of the rotor body, and wherein an angle of the abutment surface relative to the rotor axis is moveable.

2. An apparatus according to claim 1 wherein the first abutment member is moveable towards and away from the rotor so as to engage, in use, with the first axial end face of the rotor body,

3. An apparatus according to claim 1 wherein the second abutment member is moveable towards and away from the rotor so as to engage, in use, with the second axial end face of the rotor body.

4. An apparatus according to claim 1 wherein the first holding device is configured such that when the first abutment member engages with the first axial end face of the rotor body, the resulting force applied to the first axial end face urges the first rotor shaft member, preferably downwardly, towards the support device(s).

5. An apparatus according to claim 1 wherein the second holding device is configured such that when the second abutment member engages with the second axial end face of the rotor body, the resulting force applied to the second axial end face urges the second rotor shaft member, preferably downwardly, towards the support device(s).

6. An apparatus according to claim 1 wherein the first and second abutment members are each moveably mounted relative to a respective projecting member, such that the abutment surface aligns, preferably passively, with a plane of the axial end face of the rotor body when they engage, preferably: wherein the projecting member to which the first abutment member is mounted has an axis which extends substantially parallel to the rotor axis and wherein when the first abutment member engages with the first axial end face of the rotor body, the resulting force applied to the first axial end face causes the projecting member to pivot, preferably downwardly, towards the support device(s), and preferably wherein the axis of the projecting member is positioned above the rotor axis; and/or wherein the projecting member to which the second abutment member is mounted has an axis which extends substantially parallel to the rotor axis and wherein when the second abutment member engages with the second axial end face of the rotor body, the resulting force applied to the second axial end face causes the projecting member to pivot, preferably downwardly, towards the support device(s), and preferably wherein the axis of the projecting member is positioned above the rotor axis.

7. (canceled)

8. (canceled)

9. An apparatus according to claim 1 wherein the apparatus includes support structure for supporting the components of the apparatus relative to a floor surface, and wherein the first holding device is connected to the support structure by a respective deformable member which deforms when first abutment member engages the respective axial end face of the rotor body-, preferably wherein the deformable member is configured preferentially to deform at a position or location which is positioned at or below a horizontal plane in which the rotor axis A is positioned.

10. (canceled)

11. An apparatus according to claim 1 wherein the apparatus includes support structure for supporting the components of the apparatus relative to a floor surface, and wherein the second holding device is connected to the support structure by a respective deformable member which deforms when second abutment member engages the respective axial end face of the rotor body-, preferably wherein the deformable member is configured preferentially to deform at a position or location which is positioned at or below a horizontal plane in which the rotor axis A is positioned.

12. (canceled)

13. An apparatus according to claim 1 wherein the first and second holding devices are moveable towards and away from the rotor body and each other, preferably by one or more hydraulic devices.

14. An apparatus according to claim 1 wherein the first and second holding devices are positioned substantially opposite each other.

15. An apparatus according to claim 1 wherein the apparatus includes a third holding device positioned at the same respective side of the rotor as the first holding device, the third holding device including a third abutment member which is moveable towards and away from the rotor so as to engage, in use, with the first axial end face of the rotor body, said third holding device preferably including some or all of the features of the first holding device, and preferably wherein the apparatus includes a support structure for supporting the components of the apparatus relative to a floor surface, and wherein the third holding device is connected to the support structure by a deformable member which deforms when the third abutment member engages the respective axial end face of the rotor body-, more preferably wherein the deformable member is configured preferentially to deform at a position or location which, in use, is positioned above a horizontal plane in which the third abutment member of third holding device is positioned.

16. (canceled)

17. (canceled)

18. An apparatus according to claim 1 wherein the apparatus includes a fourth holding device positioned at the same respective side of the rotor as the second holding device, the fourth holding device including a fourth abutment member which is moveable towards and away from the rotor so as to engage, in use, with the second axial end face of the rotor body, said fourth holding device preferably including some or all of the features of the second holding device, and preferably wherein the apparatus includes support structure for supporting the components of the apparatus relative to a floor surface, and wherein the fourth holding device is connected to the support structure by a deformable member which deforms when fourth abutment member engages the respective axial end face of the rotor body, more preferably wherein the deformable member is configured preferentially to deform at a position or location which, in use, is positioned above a horizontal plane in which the fourth abutment member of fourth holding device is positioned.

19. (canceled)

20. (canceled)

21. An apparatus according to claim 11 wherein the third and fourth holding devices are positioned substantially opposite each other, and/or wherein the first and third holding devices are spaced from each other substantially evenly either side of a vertical plane which extends through the rotor axis, and/or wherein the second and fourth holding devices are spaced from each other substantially evenly either side of a vertical plane which extends through the rotor axis.

22. (canceled)

23. (canceled)

24. An apparatus according to claim 1 wherein the apparatus includes a first drilling device for removing material from the rotor body, said first drilling device being positioned to the same side of the rotor as the first holding device, preferably wherein the apparatus includes a second drilling device for removing material from the rotor body, said first drilling device being positioned to the same side of the rotor as the second holding device, more preferably wherein the first and second drilling devices are positioned substantially opposite each other.

25. (canceled)

26. (canceled)

27. An apparatus according to claim 1 wherein the apparatus includes a device for effecting rotation of the rotor about is rotational axis, said device preferably including one or more flexible members which engage with a peripheral surface of the rotor body so as to cause rotation thereof.

28. An apparatus according to claim 1 wherein the apparatus includes:
a first support device for engaging, in use, with the first rotor shaft member, said first support device supporting the first rotor shaft member for rotation about a rotational axis of the rotor, and
a second support device for engaging, in use, with the second rotor shaft member, said second support device supporting the second rotor shaft member for rotation about the rotational axis of the rotor, preferably wherein the first and second support devices each includes a pair of rotatable members spaced from each other and rotatable about axes which are parallel to the rotational axis of the rotor, the rotatable members preferably being positioned in a plane vertically below the rotor axis, e.g. closer to a floor surface which supports the apparatus.

29. (canceled)

30. An apparatus according to claim 1 wherein the first abutment member is moveable towards and away from the rotor and the second abutment member so as to engage, in use, with the first axial end face of the rotor body and sandwich the rotor between the first and second abutment members.

31. An apparatus according to claim 17 wherein a position of the second abutment member is fixed relative to the support device, preferably wherein the apparatus includes a substructure which is connected to the support structure, the substructure having a fixed first arm supporting the first, and preferably a third, holding devices and a moveable second arm supporting the second, and preferably a fourth, holding devices, with the second arm being moveable towards and away from the first arm, e.g. by a hydraulic actuation device, more preferably wherein the first arm supports the first and third holding devices such that the first abutment member is positioned closer to the first axial end face of the rotor than the third abutment member.

32. (canceled)

33. (canceled)

34. An apparatus according to claim 18 wherein the apparatus includes a fourth holding device positioned at the same respective side of the rotor as the second holding device, the fourth holding device including a fourth abutment member which is moveable towards and away from the rotor so as to engage, in use, with the second axial end face of the rotor body, said fourth holding device preferably including some or all of the features of the second holding device, wherein the second arm supports the second and fourth holding devices such that the second abutment member is positioned closer to the second axial end face of the rotor than the fourth abutment member.

35. An apparatus according to claim 1 including a device for sensing or determining an amount of unbalance in the rotor at one or more balancing planes thereof.
